(19) United States
(12) Patent Application Publication
(10) Pub. No.: US 2019/0193022 A1
(43) Pub. Date: Jun. 27, 2019

(54) Gas Separation Membrane

(71) Applicant: Asahi Kasei Kabushiki Kaisha, Tokyo (JP)

(72) Inventors: Azusa Yamanaka, Tokyo (JP); Yasutaka Kurishita, Tokyo (JP); Masato Mikawa, Tokyo (JP); Kimiya Murakami, Tokyo (JP); Masahiko Kawashima, Tokyo (JP)

(73) Assignee: Asahi Kasei Kabushiki Kaisha, Tokyo (JP)

(21) Appl. No.: 16/328,988

(22) PCT Filed: Aug. 7, 2017
(86) PCT No.: PCT/JP2017/028631

§ 371 Date: Feb. 27, 2019

(30) Foreign Application Priority Data
Aug. 31, 2016 (JP) 2016-169557
Feb. 15, 2017 (JP) 2017-026214
Mar. 3, 2017 (JP) 2017-040880
Mar. 3, 2017 (JP) 2017-040889

(51) Int. Cl. B01D 53/22; B01D 71/08; B01D 71/34; B01D 69/02; B01D 69/12

(52) U.S. Cl. CPC B01D 53/228; B01D 71/08; B01D 71/34; B01D 69/02; B01D 2256/24; B01D 2325/04; B01D 2325/02; B01D 2325/16; B01D 69/12

(57) ABSTRACT

Provided is a gas separation membrane for purifying mixed raw material gas including condensable gas, said gas separation membrane exhibiting excellent separation ability and being capable of maintaining a gas permeation rate at a high level for a long time under a condensable gas atmosphere.

### FIELD

The present invention relates to a gas separation membrane for purifying a mixed raw material gas including condensable gas.

### BACKGROUND

Separation and concentration of gases using gas separation membranes is associated with more excellent energy efficiency and higher safety compared to distillation or high-pressure adsorption methods. Prior practical examples include hydrogen separation by ammonia production processes. Recently, as described in PTLs 1, 2 and 3, methods using gas separation membranes to remove and recover carbon dioxide, a greenhouse gas, from synthetic gas, natural gas or the like are also being actively studied.

The common form of a gas separation membrane is to have a separation active layer (separation layer) formed on the surface of a substrate membrane. Such a form is effective for imparting a certain degree of strength to the membrane while increasing the amount of gas permeation. The separation layer in this case is a layer consisting of only a gas separating polymer.

The performance of a gas separation membrane is usually represented by the indices of permeation rate and separation factor. The permeation rate is represented by the following formula:

Permeation rate=(permeability coefficient of gas separating polymer)/(thickness of separation layer).

As clearly indicated by this formula, in order to obtain a membrane with a high permeation rate it is necessary for the thickness of the separation layer to be as small as possible. The separation factor is a value represented by the ratio of the permeation rates of the two gases that are to be separated, and this depends on the material of the gas separating polymer.

Since the pores of the substrate membrane are sufficiently large with respect to gas, the substrate membrane itself usually has no ability to separate gases, and is considered to function as a support that supports the separation active layer.

An olefin separating membrane is a membrane that separates olefin components such as ethylene, propylene, 1-butene, 2-butene, isobutene and butadiene from two or more mixed gases. Such mixed gases include, in addition to olefins, also mainly paraffins such as ethane, propane, butane and isobutane. Since olefins and paraffins in a mixed gas have similar molecular sizes, the separation factor is generally small for a dissolution and diffusion separation mechanism. However, it is known that since olefins have affinity for silver ions and copper ions, with which they form complexes, the olefins can be separated from mixed gases by an accelerated transport permeation mechanism utilizing that complex formation.

An accelerated transport permeation mechanism is a separation mechanism utilizing the affinity between the target gas and the membrane. The membrane itself may have affinity for the gas, or the membrane may be doped with a component having affinity for the gas.

Accelerated transport permeation mechanisms commonly have higher separation factors than dissolution and diffusion separation mechanisms. However, in order to obtain high affinity with olefins using an accelerated permeation mechanism for olefin separation, it is necessary for the metal species to be an ion. The separation active layer must therefore include water and an ionic liquid, and consequently the separation active layer is usually in the form of a gel membrane.

Techniques are also known for separating carbon dioxide by accelerated transport permeation mechanisms (carbon dioxide separating membranes), similar to olefin separation membranes. Carbon dioxide generally has affinity for amino groups, and such separation techniques utilize that affinity. Such types of carbon dioxide separating membranes likewise contain water and an ionic liquid in the membrane, and the gas separation active layer is usually in the form of a gel membrane.

In an accelerated transport permeation mechanism, when the amount of moisture in the separation active layer decreases, it becomes no longer possible to maintain affinity with the target gas components such as olefins or carbon dioxide, and the permeability of the target gas component is notably reduced. Therefore, it is important to maintain a state that includes moisture, in order to maintain the performance of the separation active layer.

### CITATION LIST

### Patent Literature

[PTL 1] International Patent Publication No. WO2014/157069

[PTL 2] Japanese Unexamined Patent Publication No. 2011-161387

[PTL 3] Japanese Unexamined Patent Publication HEI No. 9-898

[PTL 4] Japanese Patent Publication No. 5507079

[PTL 5] Japanese Patent Publication No. 5019502

[PTL 6] Japanese Unexamined Patent Publication No. 2014-208327

### SUMMARY

### Technical Problem

When a mixed raw material gas containing a condensable gas in a raw material gas is purified, the condensable gas that has permeated the separation active layer condenses in the substrate membrane, often producing a liquid sealed state that blocks the pores of the substrate membrane. The pores in the liquid sealed state create permeation resistance against gas, and the gas permeation rate is markedly reduced.

Since a gas separation membrane for separation of gas components by an accelerated transport permeation mechanism must be used in a high humidity atmosphere in order to maintain affinity with gas components, it is particularly prone to liquid sealing.

In light of these circumstances, the problem to be solved by the present invention is that of providing a gas separation membrane for purification of a mixed gas including condensable gas, which has excellent separative power and can also maintain its gas permeation rate in a condensable gas atmosphere in a high state for prolonged periods.

### Solution to Problem

As a result of diligent experimentation with the aim of solving this problem, the present inventors have found that the problem can be solved by controlling the pore diameter of the substrate membrane forming the separating membrane, and the invention has been completed upon this finding.

Specifically, the present invention provides the following.

[1] A gas separation membrane for purification of a mixed raw material gas including condensable gas, wherein the gas separation membrane has a separation active layer on a porous substrate membrane, and along the boundary between the porous substrate membrane and the separation active layer in a cross-section in the membrane thickness direction of the gas separation membrane, the porous substrate membrane either has no dense layer or has a dense layer with a thickness of less than 1 μm and an average pore diameter of smaller than 0.01 μm, and when the average pore diameter of the porous substrate membrane from the separation active layer side up to a depth of 2 μm is defined as A and the average pore diameter up to a depth of 10 μm is defined as B, A is 0.05 μm to 0.5 μm and the ratio A/B is greater than 0 and no greater than 0.9.

[2] The gas separation membrane according to [1] above, wherein the separation active layer is a layer including liquid.

[3] The gas separation membrane according to [1] or [2] above, wherein the average pore diameter A is 0.1 μm to 0.5 μm.

[4] The gas separation membrane according to [3] above, wherein the average pore diameter A is 0.25 μm to 0.5 μm.

[5] The gas separation membrane according to [4] above, wherein the average pore diameter A is 0.3 μm to 0.5 μm.

[6] The gas separation membrane according to any one of [1] to [5] above, wherein the average pore diameter B is 0.06 μm to 5 μm.

[7] The gas separation membrane according to [6] above, wherein the average pore diameter B is 0.1 μm to 3 μm.

[8] The gas separation membrane according to [7] above, wherein the average pore diameter B is 0.5 μm to 1 μm.

[9] The gas separation membrane according to any one of [1] to [8] above, wherein the ratio A/B is greater than 0 and no greater than 0.6.

[10] The gas separation membrane according to [9] above, wherein the ratio A/B is greater than 0 and no greater than 0.4.

[11] The gas separation membrane according to any one of [1] to [10] above, wherein the sum of the average pore diameters A and B (A+B) is 0.2 μm to 5.5 μm.

[12] The gas separation membrane according to [11] above, wherein the sum of the average pore diameters A and B (A+B) is 0.4 μm to 5.5 μm.

[13] The gas separation membrane according to [12] above, wherein the sum of the average pore diameters A and B (A+B) is 0.6 μm to 5.5 μm.

[14] The gas separation membrane according to any one of [1] to [13], wherein the separation active layer is partially penetrated into the porous substrate membrane, and the thickness of the penetrated separation active layer is greater than 0 and no greater than 50 μm.

[15] The gas separation membrane according to any one of [1] to [14], wherein the separation active layer includes a polymer comprising one or more functional groups selected from the group consisting of amino, pyridyl, imidazolyl, indolyl, hydroxyl, phenolyl, ether, carboxyl, ester, amide, carbonyl, thiol, thioether, sulfo and sulfonyl groups, and groups represented by the following formula:

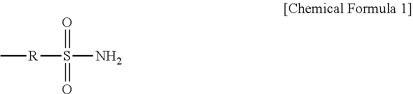

{wherein R is an alkylene group of 2 to 5 carbon atoms}.

[16] The gas separation membrane according to [15] above, wherein the polymer is a polyamine.

[17] The gas separation membrane according to [16] above, wherein the polyamine is chitosan.

[18] The gas separation membrane according to any one of [1] to [17], wherein the separation active layer contains a metal salt of a metal ion selected from the group consisting of Ag⁺ and Cu⁺.

[19] The gas separation membrane according to any one of [1] to [18], wherein the porous substrate membrane is made of a fluorine-based resin.

[20] The gas separation membrane according to [19] above, wherein the fluorine-based resin is polyvinylidene fluoride.

[21] The gas separation membrane according to any one of [1] to [20], wherein the supply side gas used is a mixed raw material gas comprising 40 mass % propane and 60 mass % propylene, the supply side gas flow rate is 190 mL/min and the permeation side gas flow rate is 50 mL/min in a humidified atmosphere, the permeation rate Q of the propylene as measured at 30° C. according to the isobaric formula in a humidified atmosphere is 15 GPU to 2,500 GPU, and the separation factor α of the propylene/propane is 50 to 2,000.

[22] An olefin separation method using the gas separation membrane according to any one of [1] to [21].

[23] A separation membrane module unit comprising a separation membrane module having a gas separation membrane according to any one of [1] to [22] fixed at bonded sections, a housing that houses the separation membrane module, humidifying means for humidification of a raw material gas to be supplied to the gas separation membrane, and dehydrating means for dehydration of a purified gas that has been purified by the gas separation membrane.

[24] The separation membrane module unit according to [23] above, wherein the purified gas is an olefin gas with a purity of 99.9% or higher.

[25] The separation membrane module unit according to [23] or [24] above, further comprising a gas purity detection system.

[26] A method for producing an olefin gas with a purity of 99.9% or higher, using the separation membrane module unit according to any one of [23] to [25] above.

[27] The method according to [26] above, wherein the olefin gas is propylene to be supplied for CVD.

[28] A continuous gas supply system which is a gas flow-type continuous gas supply system comprising a raw material gas inlet, a raw material gas purifying unit composed of a membrane module unit according to any one of [23] to [25] above, and a purified gas outlet, wherein the purity of the purified gas is 99.5% or higher.

[29] The continuous gas supply system according to [28] above, wherein the main component of the purified gas is hydrocarbon gas.

[30] The continuous gas supply system according to [29] above, wherein the purified gas contains a non-hydrocarbon gas at a total of no greater than 5000 ppm.

[31] The continuous gas supply system according to [30] above, wherein the non-hydrocarbon gas is at least one type of gas selected from the group consisting of oxygen, nitrogen, water, carbon monoxide, carbon dioxide and hydrogen.

[32] The continuous gas supply system according to [31] above, wherein the non-hydrocarbon gas is water.

[33] The continuous gas supply system according to any one of [28] to [32] above, wherein the hydrocarbon gas is an olefin gas.

[34] The continuous gas supply system according to [33] above, wherein the olefin gas is an aliphatic hydrocarbon of 1 to 4 carbon atoms.

[35] The continuous gas supply system according to [34] above, wherein the olefin gas is ethylene or propylene.

[36] The continuous gas supply system according to any one of [28] to [35] above, wherein the raw material gas used is a gaseous mixture comprising 40 mass % propane and 60 mass % propylene, the supply side gas flow rate is 190 mL/min and the permeation side gas flow rate is 50 mL/min per 2 cm² of membrane area, in a humidified atmosphere, and the separation factor α of the propylene/propane is 50 to 100,000, as measured at 30° C. according to the isobaric formula in a humidified atmosphere.

### Advantageous Effects of Invention

Since the gas separation membrane of the invention has controlled pore diameters in the substrate membrane forming the separating membrane, it can serve for purification of a mixed gas including condensable gas, and has excellent separative power and can also maintain its gas permeation rate in a condensable gas atmosphere in a high state for prolonged periods.

### BRIEF DESCRIPTION OF DRAWINGS

FIG. 1 is a schematic cross-sectional view of the gas separation membrane according to this embodiment of the invention, in the membrane thickness direction.

FIG. 2 is an SEM image of the gas separation membrane produced in Example 1-1.

FIG. 3 is an SEM image of the substrate membrane used in Example 1-1.

FIG. 4 is an SEM image of the substrate membrane used in Example 1-4.

FIG. 5 is an SEM image of the substrate membrane used in Examples 1-5 and 1-6.

FIG. 6 is an SEM image of the substrate membrane used in Comparative Example 1-1.

FIG. 7 is a simplified cross-sectional view showing an example of the construction of a gas supply system according to this embodiment (using hollow fibers).

FIG. 8 is a simplified cross-sectional view showing another example of the construction of a gas supply system according to this embodiment (using a flat membrane).

### DESCRIPTION OF EMBODIMENTS

A preferred embodiment of the invention (hereunder referred to as “this embodiment”) will now be explained in detail.

The gas separation membrane of this embodiment is a gas separation membrane for purification of a mixed raw material gas including condensable gas, the gas separation membrane having a separation active layer on a porous substrate membrane, and along the boundary between the porous substrate membrane and the separation active layer in a cross-section in the membrane thickness direction of the gas separation membrane, the porous substrate membrane either has no dense layer or has a dense layer with a thickness of less than 1 μm and an average pore diameter of smaller than 0.01 μm, and when the average pore diameter of the porous substrate membrane from the separation active layer side up to a depth of 2 μm is defined as A and the average pore diameter up to a depth of 10 μm is defined as B, A is 0.05 μm to 0.5 μm and the ratio A/B is greater than 0 and no greater than 0.9.

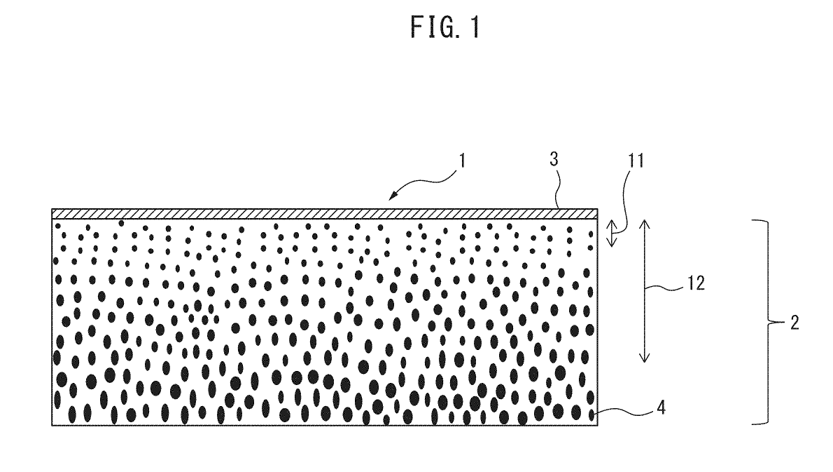

FIG. 1 is a schematic cross-sectional view of the gas separation membrane of this embodiment of the invention, in the membrane thickness direction.

The gas separation membrane 1 of FIG. 1 has a separation active layer 3 disposed on a substrate membrane 2 having a plurality of pores 4. The gas separation membrane 1 of FIG. 1 does not have a dense layer.

For the pore size distribution of the pores 4 of the substrate membrane 2 in the gas separation membrane 1 of FIG. 1, if the average pore diameter in a depth range 11 up to a depth of 2 μm from the separation active layer 3 side is defined as A and the average pore diameter in a depth range 12 up to a depth of 10 μm is defined as B, then A is 0.05 μm to 0.5 μm, and the ratio A/B is greater than 0 and no greater than 0.9.

### <Raw Material Gas>

The mixed raw material gas for this embodiment is a mixed gas of two or more gas components including the gas component to be separated. The gas component to be separated may be methane, ethane, ethylene, propane, propylene, butane, 1-butene, 2-butene, isobutane, isobutene, butadiene, monosilane, arsine, phosphine, diborane, germane, dichlorosilane, hydrogen selenide, silicon tetrachloride, disilane, boron trifluoride, boron trichloride, hydrochloric acid, ammonia, nitrogen trifluoride, silicon tetrafluoride, Freon-218, hydrogen bromide, chlorine, chlorine trifluoride, Freon-14, Freon-23, Freon-116, Freon-32, nitrous oxide, trichlorosilane, titanium tetrachloride, hydrogen fluoride, phosphorus trifluoride, phosphorus pentafluoride, tungsten hexafluoride, Freon-22, Freon-123, oxygen, nitrogen, water, carbon monoxide, carbon dioxide, hydrogen or the like. The mixed raw material gas preferably contains the gas component to be separated at 50% or greater, more preferably 90% or greater, even more preferably 95% or greater, yet more preferably 98% or greater and most preferably 99.5% or greater.

The condensable gas in the mixed raw material gas is a gas that is converted to a liquid in the usage environment, and particularly it may be water, carbon dioxide or a hydrocarbon gas of 4 or more carbon atoms.

### <Purified Gas>

The purified gas for this embodiment is a gas in which the concentration of the gas component to be separated is preferably 99.5% or greater, more preferably 99.9% or greater, even more preferably 99.99% or greater and most preferably 99.999% or greater. The gas component to be separated may be a hydrocarbon gas, for example, a paraffin gas such as methane, ethane, propane, butane or isobutane, or an olefin gas such as ethylene, propylene, 1-butene, 2-butene, isobutene or butadiene. A hydrocarbon gas in this case is a gas having both a carbon atom and hydrogen atoms in the molecule. A paraffin gas is a gas having no C—C unsaturated bonds in the molecule. An olefin gas is a gas having a C—C unsaturated bond in the molecule. Examples for the non-hydrocarbon gas include monosilane, arsine, phosphine, diborane, germane, dichlorosilane, hydrogen selenide, silicon tetrachloride, disilane, boron trifluoride, boron trichloride, hydrochloric acid, ammonia, nitrogen trifluoride, silicon tetrafluoride, Freon-218, hydrogen bromide, chlorine, chlorine trifluoride, Freon-14, Freon-23, Freon-116, Freon-32, nitrous oxide, trichlorosilane, titanium tetrachloride, hydrogen fluoride, phosphorus trifluoride, phosphorus pentafluoride, tungsten hexafluoride, Freon-22, Freon-123, oxygen, nitrogen, water, carbon monoxide, carbon dioxide, hydrogen or the like. A non-hydrocarbon gas in this case is a gas lacking either or both carbon atoms and hydrogen atoms in the molecule.

The component concentration of gases other than the target of separation in the purified gas is preferably no greater than 5000 ppm, more preferably no greater than 1000 ppm, even more preferably no greater than 100 ppm and most preferably no greater than 10 ppm. From the viewpoint of increasing process yield using the purified gas, a lower component concentration of gases other than the target of separation is preferred, but in practice it is preferably not zero from the viewpoint of safety.

Hydrocarbon gases including olefin gases, for example, are combustible gases, and may raise concerns regarding latent ignition explosion. In order to reduce the risk of ignition explosion and increase safety, it is necessary to eliminate the combustible materials, spontaneous materials or ignition sources. For example, adding water to the gases other than the hydrocarbon gas that is the target of separation can be expected to provide an effect of minimizing static electricity that acts as an ignition source.

The gases other than the target of separation need only be gases that are substantially different from the gas to be separated.

### <Gas Separation Membrane>

### [Substrate Membrane]

When a mixed gas including a condensable gas in a mixed raw material gas is purified, the condensable gas that has permeated the separation active layer condenses in the substrate membrane, often producing a liquid sealed state that blocks the pores of the substrate membrane.

The pores in the liquid sealed state produce permeation resistance against gas, and the gas permeation rate is markedly reduced.

Since a gas separation membrane for separation of gas components by an accelerated transport permeation mechanism must be used in a high humidity atmosphere in order to maintain affinity with gas components, it is particularly prone to liquid sealing. Smaller pores of the substrate membrane will tend to produce a liquid sealed state in a shorter time and lower the gas permeability.

Therefore, the substrate membrane in the gas separation membrane of this embodiment preferably either has no dense layer with small pore diameters at the boundary surface with the separation active layer, or if a dense layer with small pore diameters is present, the dense layer is preferably essentially parallel to the boundary surface and has an average pore diameter of smaller than 0.01 μm and a thickness of less than 1 μm.

By either not having a dense layer on the side of the substrate membrane with the separation active layer, or by having a dense layer with a small thickness even if it is present, the thickness of the layer that will be liquid sealed can be minimized, and a high gas permeation rate can be maintained.

The dense layer may be present at the boundary surface between the substrate membrane and the separation active layer, or it may be present inside the substrate membrane interior, or on the surface opposite from that of the separation active layer. In any of these cases, the thickness of the dense layer is preferably less than 1 μm.

The thickness of the dense layer can be determined, for example, by combining transmission electron microscopy (TEM) or gas cluster ion beam X-ray photoelectron spectroscopic analysis (GCIB-XPS) with scanning electron microscopy (SEM). The following method may be used as a specific example.

(i) The film thickness of the separation active layer is measured.

### [Using TEM]

When TEM is used, the film thickness of the separation active layer is evaluated under the following conditions, for example.

### (Pretreatment)

The gas separation membrane that has been freeze-fractured, for example, is used as the measuring sample, the outer surface of the sample is coated with a Pt coating, and it is embedded in an epoxy resin. After preparing ultrathin sections by cutting with an ultramicrotome (for example, “UC-6” by Leica Co.), they are stained with phosphotungstic acid and used as samples for microscopic examination.

### (Measurement)

The measurement may be carried out, for example, using a Model “S-5500” TEM by Hitachi, Ltd., with an acceleration voltage of 30 kV.

### [Using GCIB-XPS]

When GCIB-XPS is used, the film thickness of the separation active layer can be determined from the obtained distribution curve for the relative element concentration.

GCIB-XPS may be carried out using a Model “VersaProbell” by Ulvac-Phi, Inc., for example, under the following conditions.

### (GCIB Conditions)

Acceleration voltage: 15 kV

Cluster size: Ar2500

Cluster range: 3 mm×3 mm

Sample rotation during etching: Yes

Etching interval: 3 minutes/level

Sample current: 23 nA

Total etching time: 69 minutes

### (Xps Conditions)

X-rays: 15 kV, 25 W

Beam size: 100 μm

(ii) The thickness of the dense layer is evaluated.

The thickness of the dense layer can be evaluated from the film thickness of the separation active layer determined in (i) above and an SEM image. SEM evaluation is conducted under the following conditions, for example.

### (Pretreatment)

The gas separation membrane is freeze-fractured at a side approximately perpendicular to the boundary surface between the substrate membrane and the separation active layer and used as the measuring sample, and the cross-section of the sample is coated with platinum to prepare a sample for microscopic examination.

### (Measurement)

The measurement is carried out using a “Carry Scope (JCM-5100)” SEM by JEOL, for example, with an acceleration voltage of 20 kV.

In an observation image with a magnification of 10,000×, the pore diameters other than in the separation active layer determined in (i) are observed, and the thickness of the layer composed of pores of less than 0.01 μm is determined.

For this embodiment, if the average pore diameter of the substrate membrane up to a depth of 2 μm in the perpendicular direction from the boundary surface between the substrate membrane and the separation active layer is defined as A and the average pore diameter up to a depth of 10 μm is defined as B, then A is 0.05 μm to 0.5 μm and the ratio A/B is greater than 0 and no greater than 0.9.

The substrate membrane preferably has a larger pore diameter to minimize the liquid sealed state, but if the pore diameter is too large it will be difficult to form a separation active layer without defects. If the average pore diameter A is 0.05 μm or greater it will be possible to minimize the liquid sealed state and maintain high gas permeability. From the viewpoint of minimizing liquid sealing, the average pore diameter A is preferably 0.1 μm or greater, more preferably 0.25 μm or greater and most preferably 0.3 μm or greater. By limiting the average pore diameter A to no greater than 0.5 μm, on the other hand, it will be possible to form a separation active layer without defects.

Similar to the average pore diameter A, the average pore diameter B is also preferably 0.06 μm to 5 μm, more preferably 0.1 μm to 3 μm and even more preferably 0.5 μm to 1 μm, from the viewpoint of both minimizing the liquid sealed state and forming a separation active layer without defects.

If the ratio A/B of the average pore diameters is no greater than 0.9 it will be possible to both minimize liquid sealing and obtain defect-free coatability for the separation active layer. In order to both minimize liquid sealing and obtain defect-free coatability for the separation active layer while also obtaining a high gas permeation rate and permeation selectivity, A/B is preferably no greater than 0.6 and more preferably no greater than 0.4.

Moreover, in order to adequately exhibit an effect of minimizing liquid sealing, the sum A+B of the average pore diameters is preferably 0.2 μm to 5.5 μm. The sum of the average pore diameters indicates that when the average pore diameter A is small the average pore diameter B is preferably large, but when the average pore diameter A is sufficiently large, an adequate effect of minimizing liquid sealing can still be obtained even if the average pore diameter B is a small pore diameter, so long as A/B is no greater than 0.9. From this viewpoint, A+B is more preferably 0.4 μm or greater and most preferably 0.6 μm or greater.

The average pore diameters A and B can be determined by the following method, for example.

(i) Similar to measurement of the dense layer described above, a cross-section approximately perpendicular to the boundary surface between the substrate membrane and the separation active layer (cross-section in the membrane thickness direction) is used as the measuring sample, and the boundary surface section between the substrate membrane and separation active layer is measured with an SEM acceleration voltage of 20 kV and a magnification of 10,000×.

(ii) The average pore diameter A is calculated for a depth range of up to a depth of 2 μm of the substrate membrane from the boundary surface between the substrate membrane and separation active layer (reference numeral 11 in FIG. 1). In the range of a depth of 2 μm from the boundary surface, 5 lines are drawn at approximately equal intervals in a manner perpendicular to each of the vertical and horizontal directions, and the lengths of the portions of the lines intersecting with pores in the photograph are measured. The arithmetic mean value of the measured values is determined and recorded as the average pore diameter. In order to increase precision for the pore diameter measurement, the number of pore diameters intersected by the total of 10 vertical and horizontal lines is preferably 20 or greater. When partial separated sections of the active layer are infiltrating into the substrate membrane, the average pore diameters are measured using as reference the boundary surface between the parts of the support where the separation active layer is not infiltrating and the parts of the support where the separation active layer has infiltrated.

(iii) The average pore diameter B is calculated for a depth range of up to a depth of 10 μm of the substrate membrane from the boundary surface between the substrate membrane and separation active layer (reference numeral 12 in FIG. 1). Calculation of the average pore diameter B may be by the same method as (ii) described above, except for changing the measurement range.

The material of the substrate membrane is not particularly restricted so long as it has sufficient corrosion resistance against raw material gas and sufficient durability at the operating temperature and operating pressure, but it is preferred to use an organic material. Preferred examples of organic materials to form the substrate membrane include homopolymers of polyethersulfone (PES), polysulfone (PS), polyvinylidene fluoride (PVDF), polytetrafluoroethylene (PTFE), polyimide, polybenzooxazole and polybenzimidazole, as well as their copolymers, and any one of these or mixtures formed from them may be suitably used. Fluorine-based resins in particular have high durability in hydrocarbon atmospheres, and substrate membranes obtained from them have satisfactory workability. PVDF is most preferred from this viewpoint.

The form of the substrate membrane may be as a flat membrane or a hollow fiber.

When the substrate membrane consists of a hollow fiber, the inner diameter is appropriately selected depending on the throughput of the raw material gas, the inner diameter of a hollow fiber generally being selected in the range of 0.1 mm to 20 mm. In order to further increase contactability with the target gas component in the raw material gas, the inner diameter of the hollow fiber is preferably 0.2 mm to 15 mm. The outer diameter of the hollow fiber is not particularly restricted, and may be appropriately selected in consideration of the inner diameter of the hollow fiber, from the viewpoint of ensuring a thickness that can withstand differential pressure between the interior and exterior of the hollow fiber.

### [Separation Active Layer]

The film thickness of the gas separation active layer is preferably small, and will generally be selected between 0.01 μm to 100 μm. In order to increase the permeation rate for the target gas component that is present in the raw material gas, the thickness of the gas separation active layer is preferably 0.01 μm to 10 μm.

The separation active layer may be penetrating into a portion of the substrate membrane. Having the separation active layer penetrating to a suitable degree into the substrate membrane will increase the adhesiveness between the substrate membrane and separation active layer. The thickness of the penetrating separation active layer is preferably greater than 0 and no greater than 50 μm, and in order to ensure the permeation rate for gas components, it is more preferably no greater than 30 μm and even more preferably no greater than 20 μm.

The separation active layer is preferably a layer including a liquid, from the viewpoint of ensuring affinity with the target gas component. The liquid used is preferably water or an ionic liquid.

The separation active layer preferably includes a polymer comprising as a functional group one or more groups selected from the group consisting of amino, pyridyl, imidazolyl, indolyl, hydroxyl, phenolyl, ether, carboxyl, ester, amide, carbonyl, thiol, thioether, sulfo and sulfonyl groups, and groups represented by the following formula:

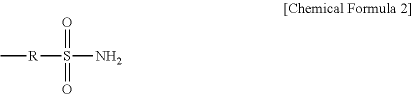

{wherein R is an alkylene group of 2 to 5 carbon atoms}.

Using a polymer containing such a functional group as the separation active layer will allow the optionally present metal salt to be dispersed at a high concentration in the separation active layer.

The separation active layer is preferably a gel polymer. A gel polymer is a polymer that swells by the action of water.

Examples of gel polymers having the aforementioned functional groups include polyamine, polyvinyl alcohol, polyacrylic acid, polyamine, polyvinyl alcohol, polyacrylic acid, poly (1-hydroxy-2-propylacrylate), polyallylsulfonic acid, polyvinylsulfonic acid, polyacrylamide methylpropanesulfonate, polyethyleneimine, gelatin, polylysine, polyglutamic acid and polyarginine. Polyamines are particularly preferred since they will allow the optionally present metal salt to be dispersed at high concentration in the separation active layer. Examples of polyamines include polyallylamine derivatives, polyethyleneimine derivatives and polyamideamine dendrimer derivatives.

The polyamine is more preferably a crystalline polymer. This will increase the durability of the separation active layer in the obtained gas separation membrane.

Chitosan is an example of a polyamine that may be suitably used for this embodiment. Chitosan is a compound containing at least β-1,4-N-glucosamine as a repeating unit, and having a β-1,4-N-glucosamine proportion of 70 mol % or greater among the total repeating units. Chitosan may also include β-1,4-N-acetylglucosamine as a repeating unit. The upper limit for the proportion of β-1,4-N-acetylglucosamine among the repeating units of chitosan is preferably no greater than 30 mol %.

The polyamine may also be chemically modified with a functional group. Preferred examples for the functional group include at least one group selected from the group consisting of imidazolyl, isobutyl and glyceryl groups.

The number-average molecular weight of the polyamine is preferably 100,000 to 3,000,000 and more preferably 300,000 to 1,500,000, from the viewpoint of a satisfactory balance between gas separation performance and permeability. The number-average molecular weight is the value obtained by measurement by size exclusion chromatography using pullulan as the standard substance.

The separation active layer preferably contains a metal salt to increase the affinity with gas components. The metal salt is preferably present in a manner dispersed in the separation active layer. Metal salts include metal salts of one or more metal ions selected from the group consisting of monovalent silver ion (Ag⁺) and monovalent copper ion (Cu⁺). More specifically, the metal salt is preferably a salt consisting of a cation selected from the group consisting of Ag⁺, Cu⁺ and their complex ions, and an anion selected from the group consisting of F⁻, Cl⁻, Br⁻, I⁻, CN⁻, NO₃⁻, SCN⁻, ClO₄⁻, CF₃SO₃⁻, BF₄⁻ and PF₆⁻, and their mixtures. Of these, Ag(NO₃) is especially preferred from the viewpoint of ready availability and product cost.

The concentration of the metal salt in the separation active layer is preferably 10 mass % to 70 mass %, more preferably 30 mass % to 70 mass % and even more preferably 50 mass % to 70 mass %. If the concentration of the metal salt is too low, it may not be possible to obtain an effect of improving the gas separation performance. If the metal salt concentration is too high, on the other hand, inconveniences such as increased production cost may result.

### <Separation Membrane Module>

The gas separation membrane module of this embodiment will now be described.

The separation membrane module of this embodiment is provided with the gas separation membrane of this embodiment as described above.

### [Structure]

When the substrate membrane is to comprise a hollow fiber, the gas separation membrane is interleaved and a fiber bundle of any desired size is produced. A single fiber may be used, or a plurality of fibers may be used together. The number of fibers when a plurality are used together is preferably 10 to 100,000, and more preferably 10,000 to 50,000. If the number is too small, problems may result such as reduced productivity for the separation membrane module. The fiber bundle may have any structure or form.

The hollow fiber bundle may be inserted into an adhesive curing mold matching the diameter of the housing to be used, and then a prescribed amount of adhesive may be injected at both ends of the fiber bundle and cured to form bonded sections, thereby producing a separation membrane module for this embodiment.

### [Bonded Section]

The bonded sections of the separation membrane module of this embodiment can potentially undergo degradation due to the gas to be separated (particularly hydrocarbon-based gas) and the metal species (especially metal salt) optionally added to the separation active layer. However, if the bonded sections each have a compositional ratio V (%) for the low mobility component calculated by pulse NMR which satisfies the relationship 30≤V≤100, and a decay rate W (%), for the signal strength (I2) at 0.05 msec after initial measurement with respect to the signal strength (I1) at initial measurement as calculated by pulse NMR in the bonded sections, which satisfies the relationship 30≤W≤100, then they will have high durability against the gas to be separated and metal species.

Commercially available adhesives commonly used in the field have a compositional ratio for low mobility component of no greater than about 30% and a signal strength decay rate of no greater than about 30%. The compositional ratio and decay rate are causes of hydrocarbon-based gas-produced swelling and infiltration of metal salts. As a result, the bonded sections undergo swelling and elution during use of the separation membrane module, causing detachment between the bonded sections and gas separation membrane, disintegration of the bonded sections and destruction of the housing, which may pose a risk of mixture between the raw material gas (gas to be separated) and purified gas (separation gas or processing gas). Therefore, the compositional ratio V for the low mobility component and the signal strength decay rate W in the bonded sections are both preferably as high as possible.

The compositional ratio V for the low mobility component calculated by pulse NMR is preferably 30% to 100%, more preferably 50% to 100%, even more preferably 70% to 100% and most preferably 90% to 100%. The decay rate W of the signal strength (I2) at 0.05 msec after initial measurement with respect to the signal strength (I1) at initial measurement, as calculated by pulse NMR, is preferably 30% to 100%, more preferably 60% to 100% and even more preferably 90% to 100%. Bonded sections wherein the relationship between V and W is satisfied will have high durability against the gas to be separated and metal species, and a highly practical membrane module can therefore be provided.

The bonded sections of the separation membrane module of this embodiment are preferably formed using an adhesive that satisfies one of the following conditions:

(1) the rate of change X (%) of the compositional ratio V2 (%) of the low mobility component with respect to the compositional ratio V1 (%) before immersion is preferably in the range of −50% to 50% and more preferably in the range of −25% to 25%, and

(2) the rate of change (Y, %) of the decay rate W1 (%) of the signal strength (I2) at 0.05 msec after initial measurement with respect to the signal strength (I1) at initial measurement, with respect to the decay rate W2 (%) before immersion, is preferably in the range of −120% to 120% and more preferably in the range of −60% to 60%,

for a test piece composed of the cured adhesive that has been immersed for 1 month in a 7 mol/L silver nitrate aqueous solution or heptane at 25° C., and more preferably they are formed using an adhesive that satisfies both conditions. Bonded sections wherein this relationship between X and Y is satisfied will have high durability against the gas to be separated and metal species, and a highly practical separation membrane module can therefore be provided.

For this embodiment, the compositional ratio (V, %) for the low mobility component obtained by pulse NMR can be calculated by the following method. Using a Minispec MQ20 by Bruker Biospin as the pulse NMR measuring apparatus, measurement is performed with 1H as the measuring nuclide, the solid echo method as the method, and a number of scans of 256. Specifically, a glass tube with an outer diameter of 10 mm containing the measuring sample cut to a height of 1.5 cm is set in an apparatus with the temperature controlled to 190° C., and the relaxation time T2 for 1H at an elapse of 5 minutes after setting is measured by the solid echo method. The repeat standby time between measurements during the measurement is set to at least 5 times the T1 relaxation time of the sample. The obtained magnetization decay curve (curve indicating time-dependent change in magnetization strength) is fitted using the following formula (1):

[Formula 1]

M(t)=Cₛexp(−(1/Wₐ)(t/Tₛ)^{W}^{ₐ})+C₁exp(−t/T₁) (1)

incorporating the Weibull function and Lorentz function. The low mobility component is defined as the component represented using the Weibull function, and the high mobility component is defined as the component represented using the Lorentz function. M(t) is the signal strength at time t, Cs and Cl are the compositional ratios (%) of the low mobility component and high mobility component, Wa is the Weibull coefficient and Ts and Tl are the relaxation times for the low mobility component and high mobility component. Fitting is so that the Weibull coefficient is 1.2 to 2.0, with 2.0 as the initial value.

From the magnetization decay curve obtained using pulse NMR by the procedure described above it is possible to calculate the decay rate W (%) of the signal strength at 0.05 msec, with 100% as the signal strength at the start of measurement, at the initial acquisition point.

The bonded sections of this embodiment are preferably formed using an adhesive whose cured product has at least one of the following physical properties (1) to (3). The bonded sections are more preferably formed using an adhesive having at least two of the following physical properties (1) to (3), and most preferably they are formed using an adhesive satisfying all of the physical properties (1) to (3).

(1) The rate of change in the bending Young's modulus and flexural strength of a test piece comprising the cured adhesive after having been immersed for 1 month in a 7 mol/L silver nitrate aqueous solution or heptane at 25° C. is in the range of −30% or greater and no more than +30% with respect to each value before immersion,

(2) the change in mass per surface area of a test piece comprising the cured adhesive after having been immersed for 1 month in a 7 mol/L silver nitrate aqueous solution or heptane at 25° C. is in the range of −30 mg/cm² or greater and no more than +30 mg/cm² compared to before immersion, and

(3) the change in thickness of a test piece comprising the cured adhesive after having been immersed for 1 month in a 7 mol/L silver nitrate aqueous solution or heptane at 25° C. is in the range of −5% or greater and no more than +5% compared to before immersion.

Bonded sections formed from an adhesive wherein the rate of change in the bending Young's modulus and the rate of change in the flexural strength of a test piece comprising the cured adhesive after having been immersed in a 7 mol/L silver nitrate aqueous solution or heptane is less than −30% or greater than 30%, can potentially undergo swelling, elution or degradation during use of the separation membrane module. When degradation of the bonded sections occurs, it can result in detachment between the bonded sections and gas separation membrane, disintegration of the bonded sections and destruction of the housing, which may pose a risk of mixture between the raw material gas (gas to be separated) and purified gas (separation gas or processing gas). In order to provide a membrane module with high practicality, it is preferred to use an adhesive that yields a cured product wherein the rate of change in the bending Young's modulus and the rate of change in the flexural strength after immersion are each −30% or greater and no more than 30%, and more preferably an adhesive is used that yields a cured product wherein each is −10% or greater and no more than 10%.

A bonded section formed from an adhesive wherein the change in mass per surface area after a test piece composed of the cured product has been immersed in a 7 mol/L silver nitrate aqueous solution or heptane is greater than 30 mg/cm² can potentially undergo swelling during use of the membrane module. When swelling of the bonded sections occurs, it poses the risk of detachment between the bonded sections and the gas separation membrane, disintegration of the bonded sections or destruction of the housing. On the other hand, bonded sections formed from an adhesive wherein the change in mass per surface area after immersion is less than −30 mg/cm² can potentially undergo elution during use of the membrane module. When elution of the bonded sections occurs, it can potentially make it difficult to strictly separate the raw material gas and purified gas. In order to provide a separation membrane module with high practical utility, therefore, it is preferred to use an adhesive that produces a cured product having a change in mass per surface area of −30 mg/cm² or greater and no more than 30 mg/cm², and it is more preferred to use an adhesive that produces a cured product having the same of −10 mg/cm² or greater and no more than 10 mg/cm².

A bonded section formed from an adhesive wherein the change in thickness after a test piece composed of the cured product has been immersed in a 7 mol/L silver nitrate aqueous solution or heptane is greater than 5% can potentially undergo swelling during use of the separation membrane module. On the other hand, a bonded section formed from an adhesive wherein the change in thickness after immersion is less than −5% can potentially undergo elution during use of the membrane module. In order to provide a membrane module with high practical utility, it is preferred to use an adhesive that produces a cured product having a change in thickness after immersion of −5% or greater and no more than 5%, and it is more preferred to use an adhesive that produces a cured product having the same of −2% or greater and no more than 2%.

The bonded sections in the separation membrane module of this embodiment preferably contain one or more selected from among cured epoxy resin-based adhesives and cured urethane resin-based adhesives.

An epoxy resin-based adhesive is composed of a base compound composed of a compound with an epoxy group, and a curing agent, and the bonded sections for the separation membrane module of this embodiment may be obtained by mixing and curing such adhesives. The epoxy resin-based adhesive may also include a curing accelerator in addition to the base compound and curing agent.

A urethane resin-based adhesive is composed of a base compound comprising a compound with a hydroxyl group, and a curing agent comprising a compound with an isocyanate group, and the bonded sections for the separation membrane module of this embodiment may be obtained by mixing and curing such adhesives.

The bonded sections in the separation membrane module of this embodiment are most preferably cured epoxy resin-based adhesives.

Examples of compounds having epoxy groups as base compounds of epoxy resin-based adhesives include bisphenol-based epoxy resins such as bisphenol A-type epoxy resin and bisphenol F-type epoxy resin; and also novolac-based epoxy resins, trisphenolmethane-based epoxy resins, naphthalene-based epoxy resins, phenoxy-based epoxy resins, alicyclic epoxy resins, glycidylamine-based epoxy resins and glycidyl ester-based epoxy resins. Of these, bisphenol-based epoxy resins are preferred from the viewpoint of strong interaction between the molecular chains and the ability to minimize swelling and degradation due to the gas to be separated and metal salts.

Examples of curing agents for epoxy resin-based adhesives include amines, polyaminoamides, phenols and acid anhydrides. Acid anhydrides are more preferably used among these. This is because cured epoxy resin-based adhesives obtained using an acid anhydride as the curing agent have strong interaction between the molecular chains and will be less likely to result in swelling and degradation of the gas to be separated and the metal salt. When an acid anhydride is used as the curing agent, the resulting bonded sections of the separation membrane module will contain an acid anhydride-epoxy resin.

Examples of acid anhydrides to be used as curing agents for epoxy resin-based adhesives include aromatic acid anhydrides such as phthalic anhydride, trimellitic anhydride, pyromellitic anhydride, benzophenonetetracarboxylic anhydride, ethyleneglycol bistrimellitate and glycerol tristrimellitate;

aliphatic acid anhydrides such as methyl-5-norbornane-2,3-dicarboxylic anhydride (methylnadic anhydride), dodecenylsuccinic anhydride, polyadipic anhydride, polyazelaic anhydride, polysebacic anhydride, poly(ethyloctadecanedioic) anhydride and poly(phenylhexadecanedioic) anhydride; and

alicyclic acid anhydrides such as methyltetrahydrophthalic anhydride, methylhexahydrophthalic anhydride, methylhymic anhydride, hexahydrophthalic anhydride, trialkyltetrahydrophthalic anhydride and methylcyclohexenedicarboxylic anhydride. Any of these may be used alone, or they may be used in admixture.

Common compounds including tertiary amines such as tris(dimethylaminomethyl)phenol, 1,8-diazabicyclo[5,4,0]undecene-7 (DBU), 1,5-diazabicyclo[4.3.0]nonene-5 (DBN) and 1,4-diazabicyclo[2.2.2]octane (DABCO); and imidazoles, Lewis acids and Bronsted acids, may be mentioned as curing accelerators that may be optionally used in the epoxy resin-based adhesive. Any of these may be used alone, or they may be used in admixture.

The types of base compound and curing agent in the epoxy resin-based adhesive used can be confirmed by measurement of the bonded sections of the separation membrane module by, for example, infrared spectroscopic analysis (IR), thermal decomposition GC/IR, thermal decomposition GC/MS, elemental analysis, Time-Of-Flight Secondary Ion Mass Spectrometry (TOF-SIMS), solid Nuclear Magnetic Resonance analysis (solid NMR) or X-ray Photoelectron Spectroscopic analysis (XPS).

The bonded sections in the separation membrane module of this embodiment preferably contain essentially no cured products of fluorine-based thermoplastic resins. Here, “contain essentially no” means that the mass ratio of cured products of fluorine-based thermoplastic resins occupying the bonded sections is no greater than 5 mass %, preferably no greater than 3 mass %, more preferably no greater than 1 mass % and even more preferably no greater than 0.1 mass %.

Fluorine-based thermoplastic resins for this embodiment are, for example, polytetrafluoroethylene (PTFE), tetrafluoroethylene-perfluoroalkylvinyl ether copolymer (PFA), tetrafluoroethylene-hexafluoropropylene copolymer (FEP), tetrafluoroethylene-ethylene copolymer (ETFE), polyvinylidene fluoride (PVDF), polychlorotrifluoroethylene (PCTFE) and chlorotrifluoroethylene-ethylene copolymer (ECTFE).

The adhesive to be used for this embodiment (and therefore the bonded sections of the separation membrane module of this embodiment) may further include various additives such as fillers, age inhibitors or reinforcing agents if necessary.

### [Gas Separation Membrane Performance]

The gas separation membrane of this embodiment can be suitably used in a humidified atmosphere.

The gas separation membrane of this embodiment is most suitably used for separation of olefins and paraffins in a humidified atmosphere. Specifically, for example, the permeation rate for propylene gas is preferably 15 GPU to 2,500 GPU and more preferably 100 GPU to 2,000 GPU, as measured by the isobaric formula in a humidified atmosphere at 30° C., using a mixed raw material gas comprising 40 mass % propane and 60 mass % propylene with respect to the gas separation membrane module with a membrane area of 42 cm², with a supply side gas flow rate of 190 mL/min and a permeation side gas flow rate of 50 mL/min. The propylene/propane separation factor is preferably 50 to 2,000 and more preferably 150 to 1,000. These values should be measured at a propylene partial pressure of no greater than 1.5 atmospheres.

The gas separation membrane performance can be measured under the following conditions, for example.

Apparatus: GTR20FMAK Isobaric Gas Permeability Measuring Device by DTR Tech.

Temperature: 25° C.

The gas separation membrane of this embodiment can also be suitably used for separation of carbon dioxide. Specifically, the permeation rate for carbon dioxide is preferably 50 GPU to 3,000 GPU, for example, and more preferably 100 GPU to 3,000 GPU, as measured by the isobaric formula in a humidified atmosphere at 30° C., using a mixed gas comprising 40 mass % carbon dioxide and 60 mass % nitrogen with respect to the gas separation membrane module with a membrane area of 2 cm², with a supply side gas flow rate of 190 mL/min and a permeation side gas flow rate of 50 mL/min. The carbon dioxide/nitrogen separation factor is preferably 100 to 100,000, more preferably 100 to 10,000 and even more preferably 100 to 1,000.

These values should be measured under conditions with a carbon dioxide partial pressure of no higher than 1 atmosphere, and specifically 0.4 atmosphere.

### <Method for Producing Gas Separation Membrane>

A method for producing a gas separation membrane of this embodiment will now be described.

The method for producing a gas separation membrane of this embodiment includes at least the following steps:

a substrate membrane production step in which a substrate membrane is produced;

a coating fluid production step in which a coating solution comprising an aqueous solution containing the gas separating polymer that is to form the separation active layer is produced; and

a coating step in which the coating solution is coated onto the surface of the substrate membrane.

The method may also include, before the coating step, an impregnation step in which the substrate membrane is impregnated with a viscous aqueous solution.

A drying step may be carried out for drying removal of the solvent in the coating solution from the substrate membrane after coating.

### (Substrate Membrane Production Step)

The method for producing a substrate membrane that is preferred for use for this embodiment will be described first.

The substrate membrane can be obtained by a non solvent-induced phase separation method or thermally induced phase separation method.

Production of a PVDF hollow fiber by a non solvent-induced phase separation method will be described.

First, PVDF is dissolved in a solvent to prepare a PVDF solution. The molecular weight of the PVDF used for this embodiment is preferably 2,000 to 100,000 and more preferably 10,000 to 50,000, as the number-average molecular weight in terms of polystyrene, measured by size exclusion chromatography. Problems may result if the molecular weight is too low, such as inability to exhibit a high level of practical durability, and problems may also result if the molecular weight is too high, such as difficulty in production of the substrate membrane.

For this embodiment, the concentration of PVDF in the PVDF solution is preferably 15 mass % to 50 mass % and more preferably 20 mass % to 35 mass %. This is because problems may result if the PVDF concentration is too low, such as inability to exhibit a high level of practical durability, and problems may also result if the PVDF concentration is too high, such as difficulty in production of the substrate membrane.

Examples of solvents to be used for the PVDF solution include good solvents such as N-methyl-2-pyrrolidone, dimethylacetamide, dimethylformamide and dimethyl sulfoxide; and poor solvents such as glycerin, ethylene glycol, triethylene glycol, polyethylene glycol and nonionic surfactants. The mass ratio of good solvent/poor solvent in the PVDF solution is preferably 97/3 to 40/60, in consideration of increasing stability when the PVDF solution is to be used as a spinning stock solution, and helping to maintain a homogeneous membrane structure.

The obtained PVDF solution is then used as a spinning stock solution for spinning. The PVDF solution is discharged from the outer slit of a double-tube nozzle, and a core liquid is discharged from the center hole. The core liquid used may be water or a mixture of water and a good solvent.

The amount of core liquid discharged is preferably 0.1 to 10 times and more preferably 0.2 times to 8 times the amount of PVDF solution discharged as the spinning stock solution. The amount of core liquid discharged and the amount of PVDF solution discharged as the spinning stock solution may be appropriately controlled to within these ranges to allow production of a substrate membrane having a preferred form.

The spinning stock solution discharged from the nozzle is passed through an air channel and then immersed in a coagulating tank, for coagulation and phase separation to form a hollow fiber. The coagulating solution used in the coagulation tank may be water, for example.

The hollow fiber that is in a moist state, lifted up from the coagulating tank, is rinsed in a rinsing tank to remove the solvent and then dried by passing through a dryer.

It is thus possible to obtain a hollow fiber by a non solvent-induced total separation method.

Production of a PVDF hollow fiber by a thermally induced phase separation method will now be described.

A mixture of PVDF, a plasticizer and silica is melt kneaded. The contents of the silica, plasticizer and PVDF are preferably in the following ranges with respect to the total amount of the silica, plasticizer and PVDF mixture. That is, the silica content is preferably 3 to 60 mass %, more preferably 7 to 42 mass % and even more preferably 15 to 30 mass %. The plasticizer content is preferably 20 to 85 mass %, more preferably 30 to 75 mass % and even more preferably 40 to 70 mass %. The PVDF content is preferably 5 to 80 mass %, more preferably 10 to 60 mass % and even more preferably 15 to 30 mass %.

If the silica content is 3 mass % or greater, the silica will be able to adequately adsorb the plasticizer, and the mixture can maintain a powder or granular state, which will be easier to mold. If it is no greater than 60 mass %, the flow property of the mixture during melting will be satisfactory, and the moldability will be increased. The strength of the obtained molded article will also be increased.

If the plasticizer content is 20 mass % or greater, the amount of plasticizer will be sufficient and adequately developed communicating pores will form, allowing a porous structure to be obtained having sufficient formation of communicating pores. If it is no greater than 85 mass %, molding will be facilitated and a substrate membrane with high mechanical strength will be obtained.

If the PVDF content is 5 mass % or greater, the amount of organic polymer resin forming the backbone of the porous structure will be sufficient, and the strength and moldability will be improved. If it is no greater than 80 mass %, a substrate membrane with sufficiently formed communicating pores can be formed.

The method of mixing the inorganic material particles, plasticizer and organic polymer resin may be a common mixing method using a blender such as a Henschel mixer, V-blender or ribbon blender. The order of mixing may be simultaneous mixing of the inorganic material particles, plasticizer and organic polymer resin, or mixing of the inorganic material particles and plasticizer to thoroughly adsorb the plasticizer onto the inorganic material particles, and then addition and mixing of the organic polymer resin. When mixing is in the latter order, the moldability during melting will be improved, the communicating pores of the obtained porous support membrane will be adequately developed, and the mechanical strength will be increased.

In order to obtain a homogeneous three-component composition, the mixing temperature is a temperature range such that the mixture is in a molten state, i.e. a temperature range of at least the melting/softening temperature and no higher than the thermal decomposition temperature of the organic polymer resin. However, the mixing temperature should be appropriately selected depending on the melt index of the organic polymer resin, the boiling point of the plasticizer, the type of inorganic material particles, and the function of the heating and kneading apparatus.

For this embodiment, the plasticizer is a liquid having a boiling point of 150° C. or higher. The plasticizer contributes to formation of a porous structure when the melt kneaded mixture is molded, and it is removed at the final stage by extraction. The plasticizer preferably is not compatible with the organic polymer resin at low temperature (ordinary temperature), but becomes compatible with the organic polymer resin during melt molding (high temperature).

Examples of plasticizers include phthalic acid esters such as diethyl phthalate (DEP), dibutyl phthalate (DBP) and dioctyl phthalate (DOP), and phosphoric acid esters. Particularly preferred among these are dioctyl phthalate and dibutyl phthalate, and their mixtures. Dioctyl phthalate is a general term for compounds having 8 carbon atoms each on two ester portions, and it includes di-2-ethylhexyl phthalate, for example.

For this embodiment, the plasticizer may be appropriately selected to control the sizes of the open pores in the porous support membrane.

Lubricants, antioxidants, ultraviolet absorbers, molding aids and the like may also be added as necessary, within ranges that do not significantly inhibit the effect of the invention.

The obtained mixture may be discharged from the outer slit of a double tube nozzle to obtain a hollow fiber molded body.

The plasticizer is extracted from the molded body using a solvent. This allows formation of a porous structure wherein the organic polymer resin has open pores and communicating pores. The solvent used for extraction is one that can dissolve the plasticizer without substantially dissolving the organic polymer resin. The solvent used for extraction may be methanol, acetone, a halogenated hydrocarbon or the like. Halogen-based hydrocarbons such as 1,1,1-trichloroethane and trichlorethylene are especially preferred.

The extraction may be extraction by a common extraction process such as a batch process or countercurrent flow multistage process. After extraction of the plasticizer, drying removal of the solvent may be carried out if necessary.

An alkali solution is then used to extract the silica from the molded body. The alkali solution used for extraction may be any one that can dissolve silica without degrading the organic polymer resin, but a caustic soda aqueous solution is especially preferred. Following extraction, the substrate membrane may be rinsed and dried if necessary.

The methods for removing the plasticizer and silica are not limited to the extraction mentioned above, and various methods that are commonly carried out may be employed.

The substrate membrane used for this embodiment is selected from among commercially available substrate membranes that have the parameters prescribed for this embodiment.

### (Impregnation Step)

The substrate membrane obtained in this manner may be supplied directly to the subsequent coating step, or it may be supplied to the coating step after an impregnation step in which the substrate membrane is impregnated with a viscous aqueous solution.

For this embodiment, the viscosity of the viscous aqueous solution is preferably 1 cP to 200 cP, more preferably 5 cP to 150 cP and even more preferably 10 cP to 100 cP. This is because if the viscosity of the viscous aqueous solution is too low, problems may occur including a lack of any effect of using the viscous aqueous solution, while problems may also occur if the viscosity of the viscous aqueous solution is too high, such as insufficient impregnation of the viscous aqueous solution into the substrate membrane.

The solute used in the viscous aqueous solution for this embodiment may be a substance that mixes with water in any desired proportion. Suitable examples that may be used include glycols and glycol ethers. Examples of glycols include glycerin, ethylene glycol, diethylene glycol, triethylene glycol, propylene glycol, dipropylene glycol, tripropylene glycol and polyethylene glycol, and examples of glycol ethers include ethyleneglycol monomethyl ether, ethyleneglycol monoethyl ether, ethyleneglycol monobutyl ether, ethyleneglycol isopropyl ether, ethyleneglycol dimethyl ether, 3-methyl 3-methoxybutanol, ethyleneglycol t-butyl ether, 3-methyl 3-methoxybutanol, 3-methoxybutanol, diethyleneglycol monomethyl ether, diethyleneglycol monobutyl ether, triethyleneglycol monomethyl ether, triethyleneglycol monobutyl ether, propyleneglycol monomethyl ether, propyleneglycol propyl ether, dipropyleneglycol monomethyl ether and tripropyleneglycol monomethyl ether. One or more selected from among glycerin, ethylene glycol and propylene glycol are preferred. Such solutes may be used alone or in admixture.

The concentration of the solute in the viscous aqueous solution is preferably 10 mass % to 90 mass % and more preferably 20 mass % to 80 mass %. A viscous aqueous solution can be prepared by mixing a solute with water in this range for adjustment to the aforementioned viscosity range.

The pH of the viscous aqueous solution is preferably 4 to 10 and more preferably 5 to 9. This is because if the pH of the viscous aqueous solution is too low or too high, sufficient impregnation of the viscous aqueous solution into the substrate membrane may not occur.

In order to increase the wettability in the substrate membrane, a surfactant may be added to the viscous aqueous solution at up to 10 mass % with respect to the total amount of the solution. Examples of surfactants include long-chain fatty acid esters of polyoxyethylene, and fluorine surfactants having perfluoro groups. Specific examples include, as examples of long-chain fatty acid esters of polyoxyethylene, Tween20® (polyoxyethylenesorbitan monolaurate), Tween40® (polyoxyethylenesorbitan monopalmitate), Tween60® (polyoxyethylenesorbitan monostearate) and Tween80® (polyoxyethylenesorbitan monooleate) (all by Tokyo Kasei Kogyo Co., Ltd.), Triton-X100, PLURONIC-F68 and PLURONIC-F127, and as examples of fluorine-based surfactants with perfluoro groups, the fluorine-based surfactants FC-4430 and FC-4432 (both by 3M), S-241, S-242 and S-243 (all by AGC Seimi Chemical Co., Ltd.) and F-444 and F-477 (both by DIC Co., Ltd.).

When the material of the substrate membrane is hydrophobic, it may be immersed in an alcohol before immersion in the viscous aqueous solution, for the purpose of causing thorough penetration of the viscous aqueous solution into the substrate membrane. Examples of preferred alcohols to be used include ethanol and methanol. The same effect can be obtained by immersion in a solution comprising a mixture of an alcohol and water.

The immersion temperature for immersion of the substrate membrane in the viscous aqueous solution is preferably 0° C. to 100° C. and more preferably 20° C. to 80° C. This is because if the immersion temperature is too low, problems may occur such as inadequate impregnation of the viscous aqueous solution into the substrate membrane, while problems may also occur if the immersion temperature is too high, such as excessive volatilization of the solvent (water) in the viscous aqueous solution during immersion.

The immersion time is preferably 15 minutes to 5 hours and more preferably 30 minutes to 3 hours. If the immersion time is too short, problems may occur such as inadequate impregnation into the substrate membrane, while problems may also occur if the immersion time is too long, such as lower production efficiency for the gas separation membrane.

### (Coating Fluid Production Step)

The separation active layer can be formed by contacting the coating solution with the substrate membrane. The contact method may be coating by, for example, a dip coating method (immersion method), doctor blade coating method, gravure coating method, die coating method or spray-coating method.

Formation of a separation active layer by contacting chitosan using a dip coating method will now be explained.

First, a chitosan coating solution is prepared. The chitosan is dissolved in an aqueous solvent to prepare a chitosan coating solution. The chitosan concentration is preferably 0.2 mass % to 10 mass % and more preferably 0.5 mass % to 5 mass %. If the chitosan concentration is less than 0.2 mass %, it may not be possible to obtain a gas separation membrane with high practical utility. The chitosan used for this embodiment may be chemically modified.

The chitosan coating solution may contain an organic solvent in a range of up to 80 mass % with respect to the total solvent. Examples for the organic solvent to be used include alcohols such as methanol, ethanol and propanol, and polar solvents such as acetonitrile, acetone, dioxane and tetrahydrofuran. Such organic solvents may be used alone or in mixtures of two or more.

The chitosan coating solution may also contain a surfactant at up to 10 mass % with respect to the total solution, in order to improve the wettability onto the substrate membrane. The surfactant used is preferably a nonionic surfactant from the viewpoint of not causing electrostatic repulsion with the material forming the separation active layer and uniformly dissolving in any acidic, neutral or basic aqueous solution.

Examples of nonionic surfactants include long-chain fatty acid esters of polyoxyethylene, and fluorine surfactants having perfluoro groups. Specific examples include, as examples of long-chain fatty acid esters of polyoxyethylene, Tween20® (polyoxyethylenesorbitan monolaurate), Tween40® (polyoxyethylenesorbitan monopalmitate), Tween60® (polyoxyethylenesorbitan monostearate) and Tween80® (polyoxyethylenesorbitan monooleate) (all by Tokyo Kasei Kogyo Co., Ltd.), Triton-X100, PLURONIC-F68 and PLURONIC-F127, and as examples of fluorine-based surfactants with perfluoro groups, the fluorine-based surfactants FC-4430 and FC-4432 (both by 3M), S-241, S-242 and S-243 (all by AGC Seimi Chemical Co., Ltd.) and F-444 and F-477 (both by DIC Co., Ltd.).

The chitosan coating solution may also have an added viscous solute at up to 20 mass % with respect to the total solution, in order to improve the flexibility of the separation active layer. The viscous solute used is preferably a glycol or glycol ether. Examples of glycols include glycerin, ethylene glycol, diethylene glycol, triethylene glycol, propylene glycol, dipropylene glycol, tripropylene glycol and polyethylene glycol, and examples of glycol ethers include ethyleneglycol monomethyl ether, ethyleneglycol monoethyl ether, ethyleneglycol monobutyl ether, ethyleneglycol isopropyl ether, ethyleneglycol dimethyl ether, 3-methyl 3-methoxybutanol, ethyleneglycol t-butyl ether, 3-methyl 3-methoxybutanol, 3-methoxybutanol, diethyleneglycol monomethyl ether, diethyleneglycol monobutyl ether, triethyleneglycol monomethyl ether, triethyleneglycol monobutyl ether, propyleneglycol monomethyl ether, propyleneglycol propyl ether, dipropyleneglycol monomethyl ether and tripropyleneglycol monomethyl ether. One or more selected from among glycerin, ethylene glycol and propylene glycol are preferred. Such solutes may be used alone or in admixture.

### (Coating Step)

The temperature of the coating solution during contact with the substrate membrane is preferably 0° C. to 100° C. and more preferably 20° C. to 80° C. If the contact temperature is too low, problems may occur such as failure for the coating solution to uniformly coat the substrate membrane, while problems may also occur if the contact temperature is too high, such as excessive volatilization of the solvent (for example, water) of the coating solution during contact.

The contact time in the case of contact by an immersion method (the immersion time) is preferably 15 minutes to 5 hours and more preferably 30 minutes to 3 hours. If the contact time is too short, problems may occur such as inadequate coating onto the substrate membrane, while problems may also occur if the contact time is too long, such as lower production efficiency for the gas separation membrane.

Pressure may also be applied to cause the separation active layer to infiltrate through to the interior of the substrate membrane during coating. The pressure will differ significantly depending on the wettability between the substrate membrane and coating solution, but for a hollow fiber, it is preferably set to a pressure of less than the pressure resistance of the substrate membrane itself and a pressure such that the coating solution does not infiltrate into the hollow section.

### (Drying Step)

An optional drying step (solvent removal step) may also be provided after the coating step. The drying step may be carried out by a method of allowing the coated substrate membrane to stand in an environment of preferably 80° C. to 160° C. and more preferably 120° C. to 160° C., for preferably 5 minutes to 5 hours and more preferably 10 minutes to 3 hours. This is because when the drying temperature is excessively low or the drying time is excessively short, or both, problems may occur such as inability for the solvent to be completely removed by drying, while problems may also occur if the drying temperature is excessively high or the drying time is excessively long, or both, such as increased production cost or reduced production efficiency.

The tensile force on the substrate membrane during drying is preferably greater than 0 and no more than 120 g. The tensile force is more preferably 2 g to 60 g, and most preferably 5 g to 30 g. Particularly when the material of the substrate membrane is a thermoplastic resin, plasticization of the substrate membrane in the drying step may result in shrinkage or stretching of the substrate membrane, often generating defects due to differences in the thermal expansion or shrinkage factor compared to the separation active layer. Moreover, the substrate membrane pore diameter may sometimes vary, thus also generating defects in some cases. By controlling the tensile force as prescribed, it is possible to form a separation active layer without defects.

### (Method for Producing Gas Separation Membrane Having Separation Active Layer Containing Metal Salt)

A gas separation membrane wherein the separation active layer contains a metal salt can be produced by further contacting a gas separation membrane obtained as described above, with a metal salt aqueous solution containing a desired metal salt. Optionally, a drying step may be carried out afterwards.

The concentration of the metal salt in the metal salt aqueous solution is preferably 0.1 mol/L to 50 mol/L. If the concentration of the metal salt in the metal salt aqueous solution is less than 0.1 mol/L, highly practical separation performance may not be exhibited when the obtained gas separation membrane is used for separation of olefins and paraffins. If the concentration exceeds 50 mol/L, inconveniences such as increased material cost may result.

Contact treatment of the gas separation membrane with the metal salt aqueous solution is preferably by an immersion method. The aqueous solution temperature during immersion is preferably 10° C. to 90° C. and more preferably 20° C. to 80° C. If the immersion temperature is too low, problems may occur such as inadequate impregnation of the metal salt into the separation active layer, while problems may also occur if the immersion temperature is too high, such as excessive volatilization of the solvent (water) in the metal salt aqueous solution during immersion.

The step of adding the metal salt to the gas separation membrane may be carried out when it is in the form of a gas separation membrane, or it may be carried out after it is formed into a module by the bonding step described below.

The gas separation membrane of this embodiment can be produced under the following conditions, for example.

### (Bonding Step)

After the coating step, a plurality of separating membranes are combined and their ends fixed with the adhesive. The number of membranes is preferably 10 to 100,000, and more preferably 10,000 to 50,000. If the number is too small, productivity for the separation membrane module may be reduced. The hollow fiber bundle may have any structure and may be in any form.

The hollow fiber or hollow fiber bundle produced as described above may be inserted into an adhesive curing mold matching the diameter of the housing to be used, and then a prescribed amount of adhesive may be injected at both ends of the fiber bundle and cured to form bonded sections.

### <Continuous Gas Supply System>

The gas supply system of this embodiment is a continuous gas supply system comprising at least a raw material gas inlet, a gas purifying unit and a purified gas outlet, the gas purifying unit comprising an absorbent-packed module, an adsorbent-packed module and/or a membrane module unit, as explained below.

By setting the gas supply system having such a construction at a location where high-purity gas is to be utilized and supplying high-purity gas, it is possible to eliminate the step of cleaning the gas tube interiors during cylinder exchange, as has been necessary during high-purity gas supply using conventional gas cylinders.

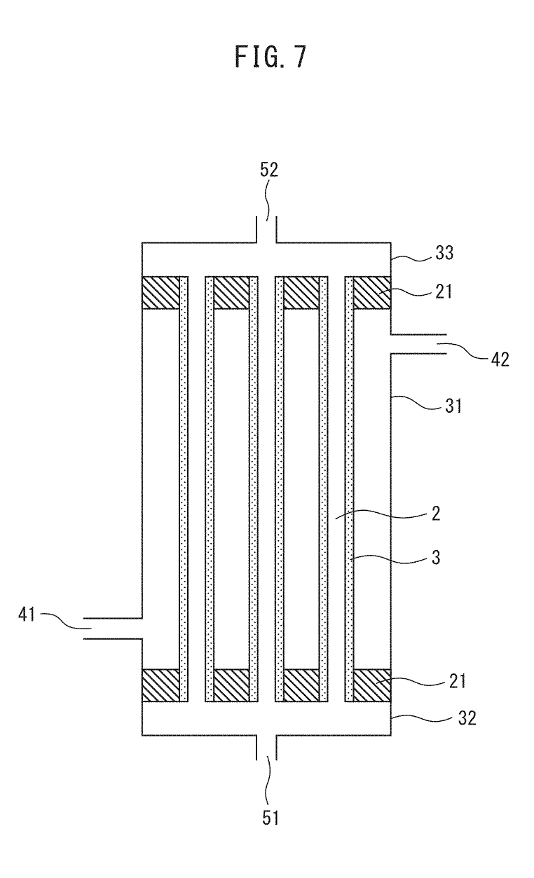

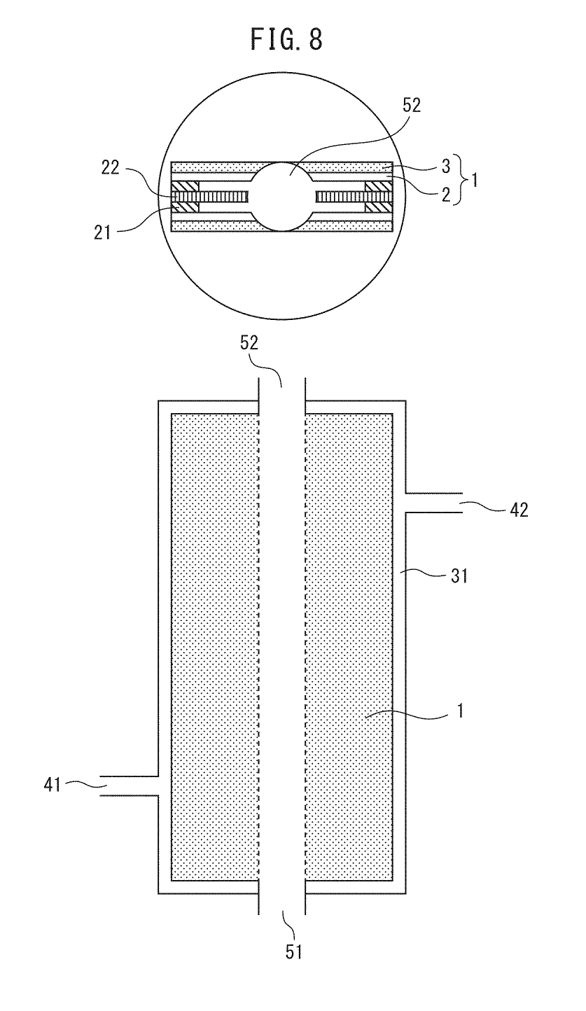

The continuous gas supply system of this embodiment will now be explained in greater detail with reference to the accompanying drawings, as a concrete mode comprising a raw material gas inlet, a gas purifying unit and a purified gas outlet in a housing, and with the separation membrane module enclosed. FIG. 7 and FIG. 8 show examples for the construction of the membrane module of this embodiment.

FIG. 7 is a simplified cross-sectional view showing an example of the membrane module in a gas supply system wherein the housing is cylindrical and the gas separation membrane is a hollow fiber type. The gas supply system of FIG. 7 houses, in a cylindrical housing 31 comprising a raw material gas inlet 41 and a process gas outlet 42, a hollow fiber-type gas separation membrane 1 comprising separation active layers 3 on the outer surfaces of hollow fiber-type substrate membranes 2, the gas separation membrane 1 being adhesively anchored to the housing 31 by bonded sections 21 and the system further comprising a footer section 32 with a transmission gas inlet 51 and a header section 33 with a purified gas outlet 52.

Both ends of the gas separation membrane 1 are not blocked, but are constructed with the transmission gas inlet 51, the hollow section of the gas separation membrane 1 and the purified gas outlet 52 allowing circulation of fluid. Circulation of fluid is also possible between the raw material gas inlet 41 and the process gas outlet 42. The hollow section of the gas separation membrane 1 and the exterior space of the gas separation membrane 1 are otherwise blocked except for contact through the gas separation membrane.

In the gas supply system shown in FIG. 7, a gas to be separated (for example, an olefin and paraffin mixture) is introduced into the module through the raw material gas inlet 41 and contacted with the surface of the gas separation membrane 1. During this time, among the components of the gas to be separated, the components with high affinity for either or both the substrate membrane 2 and separation active layer 3 (the separation gas) pass through the outer walls of the gas separation membrane 1, are released into the space inside the gas separation membrane 1, and are recovered by the purified gas outlet 52. Of the components of the gas to be separated, the components with low affinity for both the substrate membrane 2 and separation active layer 3 are discharged through the process gas outlet 42.

The transmission gas may be supplied from the transmission gas inlet 51 of the housing 31.

The transmission gas is a gas having the function of allowing recovery of the separation gas by being discharged from the purified gas outlet 52 together with the component released into the space inside the gas separation membrane 1, of the components of the gas to be separated.

The transmission gas is preferably a gas that does not react with the housing 31, bonded sections 21 or gas separation membrane 1, or with the separation gas, and an inert gas may be used, for example. Examples of inert gases include rare gases such as helium and argon, as well as nitrogen or the like.

FIG. 8 is a simplified cross-sectional view showing an example of the membrane module wherein the housing is cylindrical and the gas separation membrane is a flat membrane type. The gas supply system of FIG. 8 has a cylindrical housing 31 that comprises a transmission gas inlet 51 and a purified gas outlet 52, a raw material gas inlet 41 and process gas outlet 42 and a plate member 22 for anchoring of the gas separation membrane 1, and that houses a flat membrane-type gas separation membrane 1 comprising a separation active layer 3 on one side of a flat membrane-type substrate membrane 2, the gas separation membrane 1 being adhesively anchored by bonded sections 21 to the housing 31 via the plate member 22.

A space allowing circulation of fluid is formed between the raw material gas inlet 41 and the process gas outlet 42, the space being in contact with the side of the gas separation membrane 1 on which the separation active layer 3 is present. A space allowing circulation of fluid is also formed between the transmission gas inlet 51 and the purified gas outlet 52, and this space is in contact with the side of the gas separation membrane 1 on which the separation active layer 3 is not present. The space 1 in contact with the side of the gas separation membrane 1 on which the separation active layer 3 is present and the space 2 in contact with the side where the separation active layer 3 is not present are blocked, except for contact via the gas separation membrane.

In the gas supply system shown in FIG. 8, the gas to be separated is introduced into the space 1 of the module through the raw material gas inlet 41 and contacts the surface of the gas separation membrane 1, and only the separation gas that has high affinity with either or both the substrate membrane 2 and separation active layer 3 is released through the gas separation membrane 1 into the space 2. Of the components of the gas to be separated, the components with low affinity for both the substrate membrane 1 and separation active layer 3 are discharged directly through the space 1 out of the process gas outlet 42.

The transmission gas may be supplied from the transmission gas inlet 51 of the housing 31. The transmission gas is discharged from the purified gas outlet 52 together with the component released into the space inside the gas separation membrane 1, of the components of the gas to be separated.

The rest of this mode may be identical to the gas supply system of FIG. 7.

The raw material gas introduced into the gas purifying unit through the raw material gas inlet, after having been purified to the desired purity by the gas separation membrane, is directly supplied out from the purified gas outlet to a location that is to use the high-purity gas. That is, the purified gas outlet is the supply port for high-purity gas.

### [Absorbent-Packed Module]

The absorbent-packed module is an absorbent-packed module having an absorption column and a stripping column.

### <Absorption Column>

The absorption column has at least a column body, a gas inlet tube, an absorbing solution delivery tube and a gas delivery tube, and causes contact and absorption of the raw material gas into an absorbing solution. The column body is a closed vessel and holds an absorbing solution (agent) in its interior.

When the gas that is the target of separation is an olefin, the absorbing solution (agent) may be a metal salt aqueous solution, a solution of polyethylene glycol or the like, a cuprous chloride aqueous solution, or an ionic liquid of an imidazolium-based compound or pyridinium-based compound, among which metal salts are preferred.

The metal salt is preferably a metal salt containing a metal ion selected from the group consisting of monovalent silver (Ag⁺) and monovalent copper (Cu⁺), or their complex ions. More preferably, it is a metal salt composed of Ag⁺ or Cu⁺ or their complex ion, and an anion selected from the group consisting of F⁻, Cl⁻, Br⁻, CN⁻, NO₃⁻, SCN⁻, ClO₄⁻, CF₃SO₃⁻, BF₄⁻ and PF₆⁻. Of these, Ag(NO₃) is especially preferred from the viewpoint of ready availability and product cost.

The absorbing solution (agent) to be used when the gas that is the target of separation is carbon dioxide may be a compound including a nitrogen atom in the molecule, such as monoethanolamine, or a solution thereof, or an ionic liquid of an imidazolium-based compound or pyridinium-based compound.

The release end of the gas inlet tube is open at the lower end in the absorbing solution inside the column body, and it introduces the raw material gas into the absorption column. The end of the absorbing solution delivery unit is open in the absorbing solution inside the column body, and it delivers absorbing solution inside the absorption column to the outside of the column. The gas that has not been absorbed is delivered out of the column through the gas delivery tube of the air layer inside the column body.

### <Stripping Column>

The stripping column has at least a column body, an absorbing solution inlet tube, a gas delivery tube and an absorbing solution delivery tube, and dissipates gas that has been absorbed in the absorbing solution. The stripping column is equipped with a temperature control device for control of the absorbing solution to the prescribed temperature.

The absorbing solution inlet tube has its end open at the lower end inside the stripping column, and it introduces the absorbing solution that has been delivered by the absorption column into the stripping column. The gas delivery tube has one end open in the air layer inside the stripping column, and it delivers purified gas that has been dissipated from the absorbing solution outside of the column. The absorbing solution delivery tube has one end open at the lower end inside the stripping column, and it delivers the purified gas-dissipated absorbing solution outside of the column.

### [Adsorbent-Packed Module]

The adsorbent-packed module is an adsorbent-packed module having at least an adsorption tank.

### <Adsorption Tank>

The adsorption tank has at least a gas inlet tube and a gas delivery tube, and it adsorbs the gas that is the target of separation onto an adsorbent. The adsorbent is held inside the adsorption tank.

The introduced gas is repeatedly subjected to a process of adsorption, pressure equalization, desorption, cleaning and pressurization, while being purified to the desired purity. The gas inlet tube is open inside the adsorption tank, and it introduces pressurized raw material gas into the tank. The gas delivery tube delivers the purified gas out of the tank.

The adsorbent may be a porous MOF (Metal Organic Framework) comprising a combination of alumina, silica, zeolite, a metal ion and an organic ligand.

### [Membrane Module Unit]

The membrane module unit of this embodiment comprises a housing that encloses the separation membrane module, a humidifying mechanism (means) for humidification of a raw material gas to be supplied to the gas separation membrane, and a dehydrating mechanism (means) for dehydrating of the gas that has been purified by the gas separation membrane.

With a unit having this construction it is possible to provide a membrane module unit that effectively removes both inorganic impurities and organic impurities for prolonged periods.

### (Humidifying Mechanism)

The membrane module unit comprises a humidifying mechanism. The humidifying mechanism is preferably situated before or inside the separation membrane module. A humidifying mechanism situated before the separation membrane module may be a bubbler, for example. By bubbling the raw material gas through water, moisture at the same temperature as the bubbler temperature is entrained into the gas. A humidifying mechanism situated inside the separation membrane module may be based on a method of filling an aqueous solution into the separation active layer side of the gas separation membrane, or a method of providing a spray nozzle that supplies a mist shower to the housing. By providing a humidifying mechanism, it is possible to dissolve the inorganic impurities in the raw material gas into water.

### (Dehydrating Mechanism)

The membrane module unit comprises a dehydrating mechanism at a later stage of the separation membrane module. The dehydrating mechanism may be, for example, a mist separator, or a method utilizing an adsorbent such as alumina or zeolite. By providing a dehydrating mechanism it is possible for the inorganic impurities dissolved in water to be removed together with the water.

### (Gas Purity Detection System)

The membrane module unit preferably comprises a gas purity detection system that can measure the purity of the purified gas in an online manner within the system. The gas purity detection system may be a gas chromatography mass spectrometer, gas chromatography flame ionization detector, gas chromatography thermal conductivity detector, gas chromatography flame luminosity detector or ion chromatograph.

### EXAMPLES

The present invention will now be described in concrete detail by Examples. However, it is to be understood that the invention is not limited in any way by these Examples.

The performance of the gas separation membranes of Examples 1-1 to 1-7 and Comparative Example 1-1 were evaluated using the following evaluation methods.

### (Gas Permeability)

The gas separation membrane was immersed for 1 day in an 0.8 M sodium hydroxide solution (solvent=ethanol:water (volume ratio=80:20)), and then rinsed 5 times with distilled water and dried. The gas separation membrane was cut to 15 cm and one was fixed in a housing with an adhesive, after which it was immersed for 24 hours in a 7 M silver nitrate aqueous solution to obtain a gas separation membrane containing a silver salt. The silver salt-containing gas separation membrane was used for measurement of the permeation rates for propane and propylene.

Using a GTR20FMAK Isobaric Gas Permeability Measuring Device by DTR Tech Co., with a mixed gas comprising propane and propylene (propane:propylene=40:60 (mass ratio)) on the permeation side and helium on the supply side, the permeation rate Q for different test gases (1 GPU=1×10⁻⁶ [cm³ (STP)/cm²/s/cmHg]) was measured with a supply side gas flow rate of 50 mL/min and a permeation side gas flow rate of 50 mL/min, based on the isobaric formula (200 kPa pressurizing conditions) in a humidified atmosphere at a measuring temperature of 30° C.

Also, the selectivity α [%] was determined from the permeation rates for propylene and propane, based on the following formula:

Selectivity α[%]=propylene permeation rate (Q)/propane permeation rate (Q)×100.

### (Durability)

A TG-1k Tension and Compression Tester by Minebea Co., Ltd. was used to conduct a tensile test before and after immersion of the gas separation membrane in a heptane solution. The rate of change β in the breaking elongation after immersion in heptane for 1 day with respect to the breaking elongation before heptane immersion was calculated by the following formula:

Breaking elongation change rate β[%]=breaking elongation after heptane immersion/breaking elongation before heptane immersion)×100,

and the durability was evaluated based on the following evaluation criteria:

β [%] of 80% to 119%: Good (G),

β [%] of 50% to 79% or between 120% and 149%: Fair (F),

β [%] of ≤49% or ≥150%: Poor (P).

When the gas separation membrane was a hollow fiber-type (Examples 1-1 to 1-6 and Comparative Example 1-1), the breaking elongation was measured using the hollow fiber directly as the sample, and when the gas separation membrane was a flat membrane-type (Example 1-7), a 5 mm-wide, 70 mm-long strip was punched out of the flat membrane and used as the sample.

### Example 1-1

A polyvinylidene fluoride hollow fiber was used as the substrate membrane. The outer diameter, inner diameter and average pore diameters A and B were as shown in Table 1 below.

The hollow fiber was cut to a length of 25 cm and sealed at both ends by heat sealing, and immersed in coating (aqueous) solution A having the composition listed in Table 2 below (liquid temperature: 25° C.) at a speed of 1 cm/sec, fully immersing the entire hollow fiber in the aqueous solution, and after allowing it to stand for 5 seconds, it was lifted out at a speed of 1 cm/sec and heated at 120° C. for 10 minutes to form a separation active layer on the outer surface of the hollow fiber, thus producing a gas separation membrane.

The composition of coating solution A was an aqueous solution containing:

Chitosan: number-average molecular weight=500,000, 1 mass %

Other components: 1 mass % acetic acid, 1 mass % glycerin

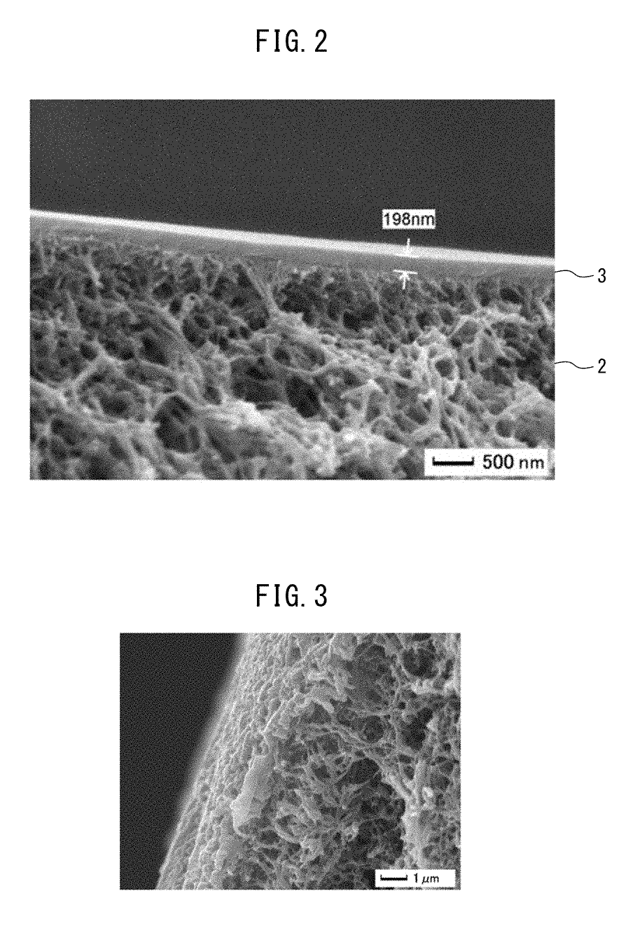

FIG. 2 shows a cross-sectional SEM image of the gas separation membrane produced in Example 1-1.

### Examples 1-2 to 1-6 and Comparative Example 1-1

Gas separation membranes were produced in the same manner as Example 1, except for using the hollow fibers listed in Table 1 below as substrate membranes and the aqueous solutions listed in Table 1 and Table 2 as aqueous coating solutions.

### Example 1-7

A Durapore VVLP04700 (trade name of Millipore, 0.1 μm pore diameter PVDF membrane filter) was used as the substrate membrane.

The coating solution D also listed in Table 2 was coated onto the support using a doctor blade applicator with a slit width of 125 μm, and dried at 80° C. for 6 hours to form a separation active layer on one side of the flat membrane-type support, thus producing a flat membrane-type gas separation membrane.

The composition of coating solution D was the following:

Chitosan: number-average molecular weight=500,000, 4 mass %

Other component: Aqueous solution containing 2 mass % acetic acid.

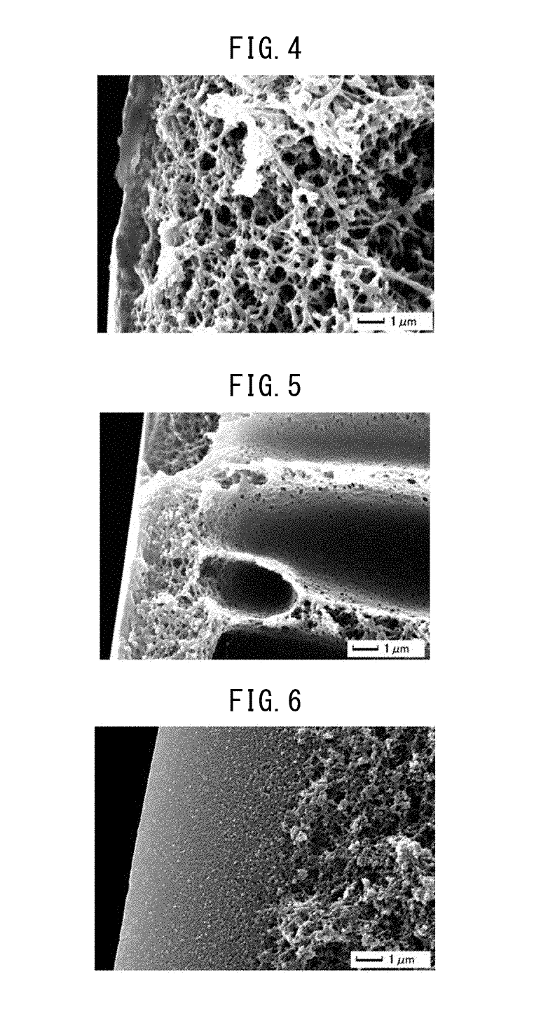

Cross-sectional SEM images near the surfaces of the substrate membranes used in Examples 1-1, 1-4, 1-5 and 1-6 and Comparative Example 1-1 are shown in FIGS. 3 to 6, respectively.

TABLE 1

| | Substrate membrane | | | | | | | |
|---|---|---|---|---|---|---|---|---|
| | | Average | Average | | | | | |
| | Dense layer | pore | pore | | | | Outer diameter/ | |
| | thickness | diameter A | diameter B | | | | inner diameter | Coating |
| | (μm) | (μm) | (μm) | A/B | A + B | Material | (μm) | solution |
| Example | None | 0.32 | 0.84 | 0.38 | 1.16 | PVDF | 1160/640 | A |
| 1-1 | | | | | | | | |
| Example | None | 0.26 | 0.51 | 0.51 | 0.77 | PVDF | 900/600 | A |
| 1-2 | | | | | | | | |
| Example | None | 0.23 | 0.28 | 0.82 | 0.53 | PVDF | 1200/680 | A |
| 1-3 | | | | | | | | |
| Example | 0.5 | 0.1 | 0.8 | 0.13 | 0.90 | PVDF | 1230/700 | B |
| 1-4 | | | | | | | | |
| Example | 0.2 | 0.18 | 0.3 | 0.67 | 0.48 | PSU | 1190/715 | C |
| 1-5 | | | | | | | | |
| Example | 0.2 | 0.18 | 0.3 | 0.67 | 0.48 | PSU | 1190/715 | C |
| 1-6 | | | | | | | | |
| Example | None | 0.1 | 0.12 | 0.83 | 0.22 | PVDF | Flat membrane | D |
| 1-7 | | | | | | | | |
| Comp. | 2.3 | 0.01 | 0.02 | 0.5 | 0.03 | PES | 460/280 | B |
| Example | | | | | | | | |
| 1-1 | | | | | | | | |

| | Separation active layer | | | | | | |
|---|---|---|---|---|---|---|---|
| | Separation | | | Gas permeability | | | |
| | active layer | Impregnation | | Q | Q | | |
| | thickness | thickness | | propylene | propane | | Durability |
| | (μm) | (μm) | Material | (GPU) | (GPU) | α | Assessment |
| Example | 0.2 | 0.2 | Chitosan | 1,060 | 2 | 530 | G |
| 1-1 | | | | | | | |
| Example | 0.2 | 0.2 | Chitosan | 780 | 1.7 | 459 | G |
| 1-2 | | | | | | | |
| Example | 0.3 | 18 | Chitosan | 150 | 0.2 | 630 | G |
| 1-3 | | | | | | | |
| Example | 0.2 | 0.3 | Chitosan | 100 | 0.8 | 125 | G |
| 1-4 | | | | | | | |
| Example | 0.2 | 0.9 | Chitosan | 45 | 0.2 | 225 | F |
| 1-5 | | | | | | | |
| Example | 0.5 | 1.3 | NAFION | 30 | 0.1 | 300 | F |
| 1-6 | | | | | | | |
| Example | 5 | 0.3 | Chitosan | 20 | Undetectable | — | G |
| 1-7 | | | | | | | |
| Comp. | 0.2 | 3.1 | Chitosan | 0.7 | Undetectable | — | G |
| Example | | | | | | | |
| 1-1 | | | | | | | |

TABLE 2

| | | Separation active | | | |
|---|---|---|---|---|---|
| | | layer material | | | |
| | | Number- | | | |
| | | average | | | |
| | | molecular | | Other components | |
| | Type | weight | Concentration | Type | Concentration |
| A | Chitosan | 500.000 | 1 mass % | Glycerin | 1 mass % |
| | | | | Acetic acid | 1 mass % |
| B | Chitosan | 500.000 | 0.5 | FC-4430 | 0.01 mass % |
| | | | mass % | Acetic acid | 0.5 mass % |
| C | NAFION | — | 5 mass % | — | — |
| D | Chitosan | 500.000 | 4 mass % | Acetic acid | 2 mass % |

The names in the “Material” column for the substrate membranes in Table 1 are the following.

PVDF: Polyvinylidene fluoride

PSU: Polysulfone

PES: Polyethersulfone

“FC-4430” in Table 2 is a fluorine-based surfactant with a perfluoroalkyl group by 3M Corp., with the trade name “Novec FC-4430”.

“NAFION” in Table 2 is a registered trademark.

From Table 1 it is seen that the gas separation membranes of Examples 1-1 to 1-7, which had separation active layers formed on substrate membranes that had no dense layer or had a dense layer with a thickness of less than 1 μm and with an average pore diameter A of 0.05 μm to 0.5 μm and an A/B ratio of greater than 0 and no greater than 0.9, had much higher propylene permeation rates, and higher propylene selectivity, in comparison to Comparative Example 1-1.

These results confirmed that by controlling the pore diameter of the substrate membrane it is possible to obtain a gas separation membrane having a high gas permeation rate in a high humidity atmosphere.

### Examples 2-1 to 2-7, Comparative Examples 2-1 to 2-4

### (Gas Permeability Evaluation)

Each gas separation membrane was immersed for 1 day in a 0.8 M sodium hydroxide solution (solvent=ethanol:water (volume ratio=80:20)), and then rinsed 5 times with distilled water and dried. The gas separation membrane was cut to 15 cm strips, 10 were used as a bundle, and the adhesive listed in Table 4 below was used to fabricate a gas separation membrane module.

It was then immersed for 24 hours in a 7 M silver nitrate aqueous solution to obtain a gas separation membrane containing a silver salt. The silver salt-containing gas separation membrane was used for measurement of the permeation rates for propane and propylene.

Measurement for Examples 2-1 to 2-6 and Comparative Example 2-1 was conducted using a gas purification system wherein 99.5% propylene (including propane, as well as carbon monoxide, carbon dioxide, ammonia, oxygen, nitrogen and NOx as impurities), having water vapor added with a bubbler at 28.5° C., was supplied to the gas separation membrane module at 30° C. at a rate of 190 cc/min, and dehydration was carried out with an alumina adsorbent.

Measurement for Example 2-7 and Comparative Example 2-2 was conducted using a gas purification system wherein 99.5% propylene (including propane, as well as carbon monoxide, carbon dioxide, ammonia, oxygen, nitrogen and NOx as impurities) was supplied to the gas separation membrane module filled with a 7 M silver nitrate aqueous solution, at 30° C. at a rate of 190 cc/min, and dehydration was carried out with an alumina adsorbent.

Measurement for Comparative Example 2-3 was conducted using a gas purification system wherein 99.5% propylene (including propane, as well as carbon monoxide, carbon dioxide, ammonia, oxygen, nitrogen and NOx as impurities) was directly supplied to the gas separation membrane module at 30° C. at a rate of 190 cc/min.

The results calculated from the composition of gas discharged from the gas purification system 3 hours after supplying the raw material gas were recorded as the results for the 1st day of measurement, and the results obtained 7 days after the initial supply were recorded as the results for the 7th day of measurement.

### Example 2-1

A polyvinylidene fluoride hollow fiber was used as a porous membrane. The outer diameter, inner diameter and average pore diameters A and B were as shown in Table 3 below.

The hollow fiber support was cut to a length of 25 cm and sealed at both ends by heat sealing, and immersed in coating solution A (liquid temperature: 25° C.) at a speed of 1 cm/sec, fully immersing the entire support in the aqueous solution, and after allowing it to stand for 5 seconds, it was lifted out at a speed of 1 cm/sec and heated at 120° C. for 10 minutes to form a separation active layer on the outer surface of the hollow fiber support, thus producing a hollow fiber-type gas separation membrane.

### Examples 2-2 to 2-5, 2-7 and Comparative Examples 2-1, 2-3

Hollow fiber-type gas separation membranes were produced in the same manner as Example 2-1, except for using the hollow fibers listed in Table 3 below as porous membranes and the aqueous solutions listed in Table 2 and Table 3 as coating solutions.

### Example 2-6

A Durapore VVLP04700 (trade name of Millipore, 0.1 μm pore diameter PVDF membrane filter) was used as the porous membrane.

Coating solution D was coated onto the support using a doctor blade applicator with a slit width of 125 μm, and dried at 80° C. for 6 hours to form a separation active layer on one side of the flat membrane-type support, thus producing a flat membrane-type gas separation membrane.

### Comparative Example 2-2

The hollow fiber listed in Table 3 as a porous membrane was directly used as a gas separation membrane without coating a separation active layer.

### Comparative Example 2-4

Measurement was performed with a commercially available high-purity propylene gas cylinder, without using a gas purification system.

The results calculated from the composition 3 hours after initial supply of the high-purity propylene gas from the gas cylinder were recorded as the results for the 1st day of measurement, and the results obtained 7 days after the initial supply were recorded as the results for the 7th day of measurement. The results calculated from the composition immediately after gas cylinder exchange were also recorded. The separation gas was analyzed using gas chromatography (GC).

The analysis results are shown in Table 5 below.

The purity of the purified gas was drastically lower immediately after gas cylinder exchange. Approximately 15 hours were required for purification to be restored to 99.99% or greater.

TABLE 3

| | Substrate membrane | | | | | | | | | |
|---|---|---|---|---|---|---|---|---|---|---|
| | | | | | | | Outer | | | |
| | | Dense | Average | Average | | | diameter/ | | | |
| | | layer | pore | pore | | | inner | Separation active layer | | |
| | | thickness | diameter A | diameter B | | | diameter | Coating | | Thickness |
| | Material | (μm) | (μm) | (μm) | A/B | Form | (μm) | solution | Material | (μm) |
| Example | PVDF | None | 0.32 | 0.8 | 0.38 | Hollow | 1160/ | A | Chitosan | 0.2 |
| 2-1 | | | | | | fiber | 640 | | | |
| Example | PVDF | 0.5 | 0.1 | 0.8 | 0.13 | Hollow | 1230/ | B | Chitosan | 0.2 |
| 2-2 | | | | | | fiber | 700 | | | |
| Example | PSU | 0.2 | 0.18 | 0.3 | 0.67 | Hollow | 1190/ | B | Chitosan | 0.2 |
| 2-3 | | | | | | fiber | 715 | | | |
| Example | PSU | 0.2 | 0.18 | 0.3 | 0.67 | Hollow | 1190/ | C | NAFION | 0.5 |
| 2-4 | | | | | | fiber | 715 | | | |
| Example | PSU | 0.2 | 0.18 | 0.3 | 0.67 | Hollow | 1190/ | B | Chitosan | 0.2 |
| 2-5 | | | | | | fiber | 715 | | | |
| Example | PVDF | None | 0.1 | 0.12 | 0.83 | Flat | — | D | Chitosan | 5 |
| 2-6 | | | | | | membrane | | | | |
| Example | PVDF | None | 0.32 | 0.8 | 0.38 | Hollow | 1160/ | A | Chitosan | 0.2 |
| 2-7 | | | | | | fiber | 640 | | | |
| Comp. | PES | 2.3 | 0.01 | 0.5 | 0.5 | Hollow | 460/ | B | Chitosan | 0.1 |
| Example | | | | | | fiber | 280 | | | |
| 2-1 | | | | | | | | | | |
| Comp. | PVDF | 2 | 0.01 | 0.1 | 0.1 | Hollow | 1130/ | None | None | None |
| Example | | | | | | fiber | 700 | | | |
| 2-2 | | | | | | | | | | |
| Comp. | PVDF | None | 0.32 | 0.8 | 0.38 | Hollow | 1160/ | A | Chitosan | 0.2 |
| Example | | | | | | fiber | 640 | | | |
| 2-3 | | | | | | | | | | |

| | Adhesive | | | | |
|---|---|---|---|---|---|
| | | Low mobility | | | |
| | | component | Signal | | |
| | | compositional | strength | | |
| | | ratio | decay rate | Humidifying | Dehydrating |
| | Adhesive | V (%) | W (%) | mechanism | mechanism |
| Example | E | 96 | 98 | Bubbler-type | Alumina |
| 2-1 | | | | | |
| Example | E | 96 | 98 | Bubbler-type | Alumina |
| 2-2 | | | | | |
| Example | F | 79 | 67 | Bubbler-type | Alumina |
| 2-3 | | | | | |
| Example | E | 96 | 98 | Bubbler-type | Alumina |
| 2-4 | | | | | |
| Example | H | 28 | 27 | Bubbler-type | Alumina |
| 2-5 | | | | | |
| Example | G | 54 | 34 | Bubbler-type | Alumina |
| 2-6 | | | | | |
| Example | E | 96 | 98 | Solution-filled | Alumina |
| 2-7 | | | | | |
| Comp. | H | 28 | 27 | Bubbler-type | Alumina |
| Example | | | | | |
| 2-1 | | | | | |
| Comp. | H | 28 | 27 | Solution-filled | Alumina |
| Example | | | | | |
| 2-2 | | | | | |
| Comp. | H | 28 | 27 | None | None |
| Example | | | | | |
| 2-3 | | | | | |

TABLE 4

| | Base compound | | Curing agent | | |
|---|---|---|---|---|---|
| | | Mixing | | Mixing | |
| | | ratio | | ratio | |
| | Structure | (mass %) | Structure | (mass %) | Curing conditions |
| E | Alicyclic epoxy resin | 50 | Alicyclic acid anhydride | 50 | 110° C., 3 hours → 130° C., 3 hours |
| F | Bis A-type epoxy resin | 40 | Alicyclic acid anhydride | 60 | 120° C., 3 hours |
| G | Naphthalene-based | 75 | Alicyclic acid anhydride | 25 | 120° C., 1.5 hours |
| | epoxy resin | | | | |
| H | Alicyclic epoxy resin | 75 | Alicyclic acid anhydride | 25 | 110° C., 3 hours → 130° C., 3 hours |

TABLE 5

| | 1st day | | | | 7th day | | | | Immediately after gas cylinder exchange | | | |
|---|---|---|---|---|---|---|---|---|---|---|---|---|
| | Propylene | Moisture | | Inorganic | Propylene | Moisture | | Inorganic | Propylene | Moisture | | Inorganic |
| | purity | content | Paraffin | impurities | purity | content | Paraffin | impurities | purity | content | Paraffin | impurities |
| | (%) | ppm | (%) | (ppm) | (%) | ppm | (%) | (ppm) | (%) | ppm | (%) | (%) |
| Example | 99.999 | 3 | 0.0005 | 2 | 99.999 | 3 | 0.0005 | 2 | — | — | — | — |
| 2-1 | | | | | | | | | | | | |
| Example | 99.993 | 4 | 0.006 | 4 | 99.992 | 4 | 0.007 | 4 | — | — | — | — |
| 2-2 | | | | | | | | | | | | |
| Example | 99.994 | 5 | 0.005 | 4 | 99.99 | 5 | 0.009 | 4 | — | — | — | — |
| 2-3 | | | | | | | | | | | | |
| Example | 99.991 | 5 | 0.008 | 4 | 99.986 | 5 | 0.013 | 3 | — | — | — | — |
| 2-4 | | | | | | | | | | | | |
| Example | 99.982 | 5 | 0.017 | 5 | 99.924 | 5 | 0.075 | 5 | — | — | — | — |
| 2-5 | | | | | | | | | | | | |
| Example | 99.997 | 6 | 0.002 | 5 | 99.997 | 5 | 0.002 | 5 | — | — | — | — |
| 2-6 | | | | | | | | | | | | |
| Example | 99.998 | 5 | 0.001 | 6 | 99.998 | 5 | 0.001 | 6 | — | — | — | — |
| 2-7 | | | | | | | | | | | | |
| Comp. | 99.991 | 4 | 0.008 | 6 | 99.744 | 4 | 0.255 | 6 | — | — | — | — |
| Example | | | | | | | | | | | | |
| 2-1 | | | | | | | | | | | | |
| Comp. | 99.851 | 4 | 0.148 | 5 | 99.761 | 4 | 0.238 | 5 | — | — | — | — |
| Example | | | | | | | | | | | | |
| 2-2 | | | | | | | | | | | | |
| Comp. | 99.808 | 10 | 0.188 | 30 | 99.811 | 10 | 0.185 | 32 | — | — | — | — |
| Example | | | | | | | | | | | | |
| 2-3 | | | | | | | | | | | | |
| Comp. | 99.995 | 10 | 10 | 30 | 99.995 | 10 | 10 | 30 | 68.384 | 588 | 0.193 | 30.927 |
| Example | | | | | | | | | | | | |
| 2-4 | | | | | | | | | | | | |

From Table 3 and Table 5 it is seen that Examples 2-1 to 2-7 which used gas separation membrane modules having a separation active layer formed on a porous membrane that had no dense layer or had a dense layer with a thickness of less than 1 μm and with an average pore diameter A of 0.05 μm to 0.5 μm, an average pore diameter of less than 0.01 μm and an A/B ratio of greater than 0 and no greater than 0.9, and which were provided with a humidifying mechanism and dehydrating mechanism, produced higher purity propylene gas stably for a long period, in comparison to Comparative Examples 2-1 to 2-4.

These results confirmed that by providing a gas separation membrane module with a controlled pore diameter of the porous membrane, and a humidifying and dehydrating mechanism, it is possible to obtain a membrane module unit and continuous gas supply system that can produce high-purity gas.

### INDUSTRIAL APPLICABILITY

The gas separation membrane of the invention has a controlled pore diameter for the substrate membrane composing the gas separation membrane and thereby maintains a state with a high gas permeation rate for prolonged periods in a high humidity atmosphere, and it can therefore be suitably used for various types of gas separation.

### REFERENCE SIGNS LIST

1 Gas separation membrane
2 Substrate membrane
3 Separation active layer
4 Pore
11 Depth range for determining average pore diameter A
12 Depth range for determining average pore diameter B
21 Bonded section
22 Plate member
31 Housing
32 Footer section
33 Header section
41 Raw material gas inlet
42 Process gas outlet
51 Transmission gas inlet
52 Purified gas outlet

1. A gas separation membrane for purification of a mixed raw material gas including condensable gas, wherein the gas separation membrane has a separation active layer on a porous substrate membrane, and along the boundary between the porous substrate membrane and the separation active layer in a cross-section in the membrane thickness direction of the gas separation membrane, the porous substrate membrane either has no dense layer or has a dense layer with a thickness of less than 1 μm and an average pore diameter of smaller than 0.01 μm, and when the average pore diameter of the porous substrate membrane from the separation active layer side up to a depth of 2 μm is defined as A and the average pore diameter up to a depth of 10 μm is defined as B, A is 0.05 μm to 0.5 μm and the ratio A/B is greater than 0 and no greater than 0.9.

2. The gas separation membrane according to claim 1, wherein the separation active layer is a layer including liquid.

3. The gas separation membrane according to claim 1 or 2, wherein the average pore diameter A is 0.1 μm to 0.5 μm.

4. The gas separation membrane according to claim 3, wherein the average pore diameter A is 0.25 μm to 0.5 μm.

5. The gas separation membrane according to claim 4, wherein the average pore diameter A is 0.3 μm to 0.5 μm.

6. The gas separation membrane according to claim 1, wherein the average pore diameter B is 0.06 μm to 5 μm.

7. The gas separation membrane according to claim 6, wherein the average pore diameter B is 0.1 μm to 3 μm.

8. The gas separation membrane according to claim 7, wherein the average pore diameter B is 0.5 μm to 1 μm.

9. The gas separation membrane according to claim 1, wherein the ratio A/B is greater than 0 and no greater than 0.6.

10. The gas separation membrane according to claim 9, wherein the ratio A/B is greater than 0 and no greater than 0.4.

11. The gas separation membrane according to claim 1, wherein the sum of the average pore diameters A and B (A+B) is 0.2 μm to 5.5 μm.

12. The gas separation membrane according to claim 11, wherein the sum of the average pore diameters A and B (A+B) is 0.4 μm to 5.5 μm.

13. The gas separation membrane according to claim 12, wherein the sum of the average pore diameters A and B (A+B) is 0.6 μm to 5.5 μm.

14. The gas separation membrane according to claim 1, wherein the separation active layer is partially penetrated into the porous substrate membrane, and the thickness of the penetrated separation active layer is greater than 0 and no greater than 50 μm.

15. The gas separation membrane according to claim 1, wherein the separation active layer includes a polymer comprising one or more functional groups selected from the group consisting of amino, pyridyl, imidazolyl, indolyl, hydroxyl, phenolyl, ether, carboxyl, ester, amide, carbonyl, thiol, thioether, sulfo and sulfonyl groups, and groups represented by the following formula: 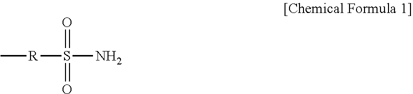
wherein R is an alkylene group of 2 to 5 carbon atoms.

16. The gas separation membrane according to claim 15, wherein the polymer is a polyamine.

17. The gas separation membrane according to claim 16, wherein the polyamine is chitosan.

18. The gas separation membrane according to claim 1, wherein the separation active layer contains a metal salt of a metal ion selected from the group consisting of Ag⁺ and Cu⁺.

19. The gas separation membrane according to claim 1, wherein the porous substrate membrane is made of a fluorine-based resin.

20. The gas separation membrane according to claim 19, wherein the fluorine-based resin is polyvinylidene fluoride.

21. The gas separation membrane according to claim 1, wherein the supply side gas used is a mixed raw material gas comprising 40 mass % propane and 60 mass % propylene, the supply side gas flow rate is 190 mL/min and the permeation side gas flow rate is 50 mL/min in a humidified atmosphere, the permeation rate Q of the propylene as measured at 30° C. according to the isobaric formula in a humidified atmosphere is 15 GPU to 2,500 GPU, and the separation factor cc of the propylene/propane is 50 to 2,000.

22. An olefin separation method using the gas separation membrane according to claim 1.

23. A separation membrane module unit comprising a separation membrane module having a gas separation membrane according to claim 1 fixed at bonded sections, a housing that houses the separation membrane module, humidifying means for humidification of a raw material gas to be supplied to the gas separation membrane, and dehydrating means for dehydration of a purified gas that has been purified by the gas separation membrane.

24. The separation membrane module unit according to claim 23, wherein the purified gas is an olefin gas with a purity of 99.9% or higher.

25. The separation membrane module unit according to claim 23, further comprising a gas purity detection system.

26. A method for producing an olefin gas with a purity of 99.9% or higher, using the separation membrane module unit according to claim 23.

27. The method according to claim 26, wherein the olefin gas is propylene to be supplied for CVD.

28. A continuous gas supply system which is a gas flow-type continuous gas supply system comprising a raw material gas inlet, a raw material gas purifying unit composed of a membrane module unit according to claim 23, and a purified gas outlet, wherein the purity of the purified gas is 99.5% or higher.

29. The continuous gas supply system according to claim 28, wherein the main component of the purified gas is hydrocarbon gas.

30. The continuous gas supply system according to claim 29, wherein the purified gas contains a non-hydrocarbon gas at a total of no greater than 5000 ppm.

31. The continuous gas supply system according to claim 30, wherein the non-hydrocarbon gas is at least one type of gas selected from the group consisting of oxygen, nitrogen, water, carbon monoxide, carbon dioxide and hydrogen.

32. The continuous gas supply system according to claim 31, wherein the non-hydrocarbon gas is water.

33. The continuous gas supply system according to claim 28, wherein the hydrocarbon gas is an olefin gas.

34. The continuous gas supply system according to claim 33, wherein the olefin gas is an aliphatic hydrocarbon of 1 to 4 carbon atoms.

35. The continuous gas supply system according to claim 34, wherein the olefin gas is ethylene or propylene.

36. The continuous gas supply system according to claim 28, wherein the raw material gas used is a gaseous mixture comprising 40 mass % propane and 60 mass % propylene, the supply side gas flow rate is 190 mL/min and the permeation side gas flow rate is 50 mL/min per 2 cm² of membrane area, in a humidified atmosphere, and the separation factor cc of the propylene/propane is 50 to 100,000, as measured at 30° C. according to the isobaric formula in a humidified atmosphere.
